(19) United States
(12) Patent Application Publication
(10) Pub. No.: US 2026/0089077 A1
(43) Pub. Date: Mar. 26, 2026

(54) CONFIGURATION METHOD AND DEVICE

(71) Applicant: GUANGDONG OPPO MOBILE TELECOMMUNICATIONS CORP., LTD., Dongguan (CN)

(72) Inventors: Boren GUO, Dongguan (CN); Yali GUO, Dongguan (CN)

(21) Appl. No.: 19/409,445

(22) Filed: Dec. 4, 2025

Related U.S. Application Data
(63) Continuation of application No. PCT/CN2023/113904, filed on Aug. 18, 2023.

(51) Int. Cl. H04L 43/0864; H04L 5/00; H04L 69/322

(52) U.S. Cl. CPC H04L 43/0864; H04L 5/0044; H04L 69/322

(57) ABSTRACT

A first network device is configured to perform: receiving a first message, where the first message indicates a round-trip (RT) delay requirement; and determining, based on the RT delay requirement, at least one of: a packet delay budget (PDB) of an uplink data flow of a service or a PDB of a downlink data flow of the service. The uplink data flow of the service is carried in a first protocol data unit (PDU) session, and the downlink data flow of the service is carried on a second PDU session.

### CROSS-REFERENCE TO RELATED APPLICATION

This application is a Continuation Application of International Application No. PCT/CN2023/113904 filed on August 18, 2023, which is incorporated herein by reference in its entirety.

### TECHNICAL FIELD

The present application relates to the field of communications, and more particularly, to configuration methods and devices.

### BACKGROUND

In related technologies, uplink and downlink collaboration only involves single user equipment (UE) scenarios, that is, the uplink data flow and downlink data flow of a service are carried in the same protocol data unit (PDU) session of a single UE. Uplink and downlink collaboration refers to allocating packet delay budgets (PDBs) for the uplink data flow and the downlink data flow respectively, and ensuring that a sum of the uplink PDB and the downlink PDB does not exceed the round-trip (RT) delay requirement.

In multi-UE scenarios, where the uplink and downlink data flows of a service are carried in different PDU sessions of different UEs, how to achieve uplink and downlink collaboration for UEs and allocate PDBs for the uplink and downlink data flows belonging to the same service and carried in different PDU sessions is a technical problem that needs to be solved.

### SUMMARY

Embodiments of the present application provide configuration methods and devices.

The embodiments of the present application provide a configuration method, including: receiving, by a first network device, a first message, where the first message indicates an RT delay requirement; and determining, by the first network device, based on the RT delay requirement, at least one of: a PDB of an uplink data flow of a service, or a PDB of a downlink data flow of the service; where the uplink data flow of the service is carried in a first PDU session, and the downlink data flow of the service is carried in a second PDU session.

The embodiments of the present application provide a configuration method, including: transmitting, by a second network device, a first message, where the first message is used to determine an RT delay requirement, and the RT delay requirement is used to determine at least one of: a PDB of an uplink data flow of a service, or a PDB of a downlink data flow of the service; where the uplink data flow of the service is carried in a first PDU session, and the downlink data flow of the service is carried in a second PDU session.

The embodiments of the present application provide a configuration method, including: receiving, by a third network device, a respective first message from each of two first network devices; determining, by the third network device, an RT delay requirement based on the first message, and determining, based on the RT delay requirement, at least one of: a PDB of an uplink data flow of a service, or a PDB of a downlink data flow of the service; where the uplink data flow of the service is carried in a first PDU session, and the downlink data flow of the service is carried in a second PDU session.

The embodiments of the present application provide a delay monitoring method, including: receiving, by a fourth network device, a monitoring request; and determining, by the fourth network device, based on the monitoring request, at least one of: a packet delay of an uplink data flow of a service, a packet delay of a downlink data flow of the service, or a packet delay between a UE and a tethered device; where the uplink data flow of the service is carried in a first PDU session, and the downlink data flow of the service is carried in a second PDU session.

The embodiments of the present application provide a delay monitoring method, including: receiving, by a fifth network device, from a fourth network device at least one of: a packet delay of an uplink data flow of a service, a packet delay of a downlink data flow of the service, or a packet delay between a UE and a tethered device; determining, by the fifth network device, a round-trip packet delay of the service based on at least one of: the packet delay of the uplink data flow of the service, the packet delay of the downlink data flow of the service, or the packet delay between the UE and the tethered device; where the uplink data flow of the service is carried in a first PDU session, and the downlink data flow of the service is carried in a second PDU session.

The embodiments of the present application provide a delay monitoring method, including: transmitting, by a sixth network device, a monitoring request; where the monitoring request is used to determine at least one of: a packet delay of an uplink data flow of a service, a packet delay of a downlink data flow of the service, or a packet delay between a UE and a tethered device; where the uplink data flow of the service is carried in a first PDU session, and the downlink data flow of the service is carried in a second PDU session.

The embodiments of the present application provide a first network device, including: a first transceiver unit, configured to receive a first message, where the first message indicates an RT delay requirement; and a first processing unit, configured to determine, based on an RT delay requirement, at least one of: a PDB of an uplink data flow of a service, or a PDB of a downlink data flow of the service; where the uplink data flow of the service is carried in a first PDU session, and the downlink data flow of the service is carried in a second PDU session.

The embodiments of the present application provide a second network device, including: a second transceiver unit, configured to transmit a first message, where the first message is used to determine an RT delay requirement, and the RT delay requirement is used to determine at least one of: a PDB of an uplink data flow of a service, or a PDB of a downlink data flow of the service; where the uplink data flow of the service is carried in a first PDU session, and the downlink data flow of the service is carried in a second PDU session.

The embodiments of the present application provide a third network device, including: a third transceiver unit, configured to receive a respective first message from each of two first network devices; and a second processing unit, configured to determine an RT delay requirement based on the first message, and determine, based on the RT delay requirement, at least one of: a PDB of an uplink data flow of a service, or a PDB of a downlink data flow of the service; where the uplink data flow of the service is carried in a first PDU session, and the downlink data flow of the service is carried in a second PDU session.

The embodiments of the present application provide a fourth network device, including: a fourth transceiver unit, configured to receive a monitoring request; and a third processing unit, configured to determine, based on the monitoring request, at least one of: a packet delay of an uplink data flow of a service, a packet delay of a downlink data flow of the service, or a packet delay between a UE and a tethered device; where the uplink data flow of the service is carried in a first PDU session, and the downlink data flow of the service is carried in a second PDU session.

The embodiments of the present application provide a fifth network device, including: a fifth transceiver unit, configured to receive, from a fourth network device, at least one of: a packet delay of an uplink data flow of a service, a packet delay of a downlink data flow of the service, or a packet delay between a UE and a tethered device; and a fourth processing unit, configured to determine a round-trip packet delay of the service based on at least one of: the packet delay of the uplink data flow of the service, the packet delay of the downlink data flow of the service, or the packet delay between the UE and the tethered device; where the uplink data flow of the service is carried in a first PDU session, and the downlink data flow of the service is carried in a second PDU session.

The embodiments of the present application provide a sixth network device, including: a sixth transceiver unit, configured to transmit a monitoring request; where the monitoring request is used to determine at least one of: a packet delay of an uplink data flow of a service, a packet delay of a downlink data flow of the service, or a packet delay between a UE and a tethered device; where the uplink data flow of the service is carried in a first PDU session, and the downlink data flow of the service is carried in a second PDU session.

The embodiments of the present application provide a communication device, including: a transceiver, a processor, and a memory. The memory is configured to store a computer program, the transceiver is configured to communicate with other devices, and the processor is configured to call and run the computer program stored in the memory to enable the communication device to perform the configuration method or the delay monitoring method.

The embodiments of the present application provide a chip for implementing the configuration method or the delay monitoring method.

For example, the chip includes: a processor, configured to call and run a computer program from a memory, to enable a device equipped with the chip to perform the configuration method or the delay monitoring method.

The embodiments of the present application provide a non-transitory computer-readable storage medium for storing a computer program, where when being executed by a device, the computer program enables the device to perform the configuration method or the delay monitoring method.

The embodiments of the present application provide a computer program product, including computer program instructions, which enable a computer to perform the configuration method or the delay monitoring method.

The embodiments of the present application provide a computer program which, when being executed on a computer, enables the computer to perform the configuration method or the delay monitoring method.

### BRIEF DESCRIPTION OF THE DRAWINGS

FIG. 1 is a schematic diagram of an application scenario according to the embodiments of the present application.

FIG. 2A is a schematic flowchart of different PDU sessions carrying different UEs in a multi-UE scenario according to an embodiment of the present application.

FIG. 2B is a schematic flowchart of different PDU sessions carrying different UEs in a multi-UE scenario according to another embodiment of the present application.

FIG. 3A is a schematic flowchart of a configuration method 3001 according to an embodiment of the present application.

FIG. 3B is a schematic flowchart of a configuration method 3002 according to an embodiment of the present application.

FIG. 3C is a schematic flowchart of a configuration method 3003 according to an embodiment of the present application.

FIG. 4 is a schematic flowchart of a configuration method 400 according to an embodiment of the present application.

FIG. 5 is a schematic flowchart of a configuration method 500 according to an embodiment of the present application.

FIG. 6 is a flowchart of the implementation of Embodiment I of the present application.

FIG. 7 is a flowchart of the implementation of Embodiment II of the present application.

FIG. 8 is a flowchart of the implementation of Embodiment III of the present application.

FIG. 9 is a flowchart of the implementation of Embodiment IV of the present application.

FIG. 10 is a flowchart of the implementation of Embodiment V of the present application.

FIG. 11 is a schematic flowchart of a delay monitoring method 1100 according to an embodiment of the present application.

FIG. 12 is a schematic flowchart of a delay monitoring method 1200 according to an embodiment of the present application.

FIG. 13 is a schematic flowchart of a delay monitoring method 1300 according to an embodiment of the present application.

FIG. 14 is a flowchart of Embodiment VI of the present application.

FIG. 15 is a flowchart of Embodiment VII of the present application.

FIG. 16 is a schematic block diagram of a first network device 1600 according to an embodiment of the present application.

FIG. 17 is a schematic block diagram of a second network device 1700 according to an embodiment of the present application.

FIG. 18 is a schematic block diagram of a third network device 1800 according to an embodiment of the present application.

FIG. 19 is a schematic block diagram of a fourth network device 1900 according to an embodiment of the present application.

FIG. 20 is a schematic block diagram of a fifth network device 2000 according to an embodiment of the present application.

FIG. 21 is a schematic block diagram of a sixth network device 2100 according to an embodiment of the present application.

FIG. 22 is a schematic structural diagram of a communication device 2200 according to the embodiments of the present application.

FIG. 23 is a schematic structural diagram of a chip 2300 according to the embodiments of the present application.

### DETAILED DESCRIPTION

The technical solutions in the embodiments of the present application will be described below in conjunction with the drawings in the embodiments of the present application.

The technical solutions of the embodiments of the present application may be applied to various communication systems, such as, a Long Term Evolution (LTE) system, an Advanced Long Term Evolution (LTE-A) system, a New Radio (NR) system, an evolution system of the NR system, an LTE-based access to unlicensed spectrum (LTE-U) system, an NR-based access to unlicensed spectrum (NR-U) system, a Non-Terrestrial Networks (NTN) system, a Universal Mobile Telecommunication System (UMTS), Wireless Local Area Networks (WLAN), Wireless Fidelity (WiFi), a 5th-Generation (5G) system or other communication systems.

Generally speaking, a number of connections supported by a traditional communication system is limited and is easy to implement, however, with the development of the communication technology, the mobile communication system will not only support the traditional communication, but also support, for example, device to device (D2D) communication, machine to machine (M2M) communication, machine type communication (MTC), vehicle to vehicle (V2V) communication, or vehicle to everything (V2X) communication, etc., and the embodiments of the present application may also be applied to these communication systems.

In an implementation, the communication system in the embodiments of the present application may be applied to a carrier aggregation (CA) scenario, a dual connectivity (DC) scenario, or a standalone (SA) networking scenario.

In an implementation, the communication system in the embodiments of the present application may be applied to an unlicensed spectrum, where the unlicensed spectrum may also be considered as a shared spectrum; or, the communication system in the embodiments of the present application may also be applied to an licensed spectrum, where the licensed spectrum may also be considered as an unshared spectrum.

The embodiments of the present application describe various embodiments in conjunction with a network device and a terminal device. The terminal device may also be referred to as user equipment (UE), an access terminal, a user unit, a user station, a mobile station, a mobile platform, a remote station, a remote terminal, a mobile device, a user terminal, a terminal, a wireless communication device, a user agent, a user device, or the like.

The terminal device may be a station (ST) in WLAN, which may be a cellular phone, a cordless phone, a session initiation protocol (SIP) phone, a wireless local loop (WLL) station, a personal digital assistant (PDA) device, a handheld device with wireless communication functions, a computing device or other processing devices connected to a wireless modem, an in-vehicle device, a wearable device, a terminal device in a next-generation communication system (such as an NR network), a terminal device in a future evolved public land mobile network (PLMN) network, or the like.

In the embodiments of the present application, the terminal device may be deployed on land, including indoor or outdoor, handheld, wearable or in-vehicle; the terminal device may also be deployed on water surface (e.g., on a steamship); and the terminal device may also be deployed in air (e.g., on an airplane, on a balloon, or on a satellite).

In the embodiments of the present application, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like.

By way of example and not limitation, in the embodiments of the present application, the terminal device may also be a wearable device. The wearable device may also be referred to as a wearable smart device, which is a general term for wearable devices developed by using wearable technology and intelligent design for everyday wear, such as glasses, gloves, a watch, clothing, or shoes. The wearable device is a portable device that is worn directly on a body, or integrated into a user’s clothing or accessories. The wearable device is not only a hardware device, but also implements powerful functions through software support as well as data interaction or cloud interaction. Generalized wearable smart devices include full-featured, large-sized devices that may implement full or partial functionality without relying on smart phones, such as a smart watch or smart glasses, and devices that focus on a certain type of application functionality only and need to be used in conjunction with other devices (such as smart phones), such as various smart bracelets or smart jewelries for monitoring physical signs.

In the embodiments of the present application, the network device may be a device for communicating with a mobile device. The network device may be an access point (AP) in WLAN, an evolutional base station (Evolutional Node B, eNB or eNodeB) in LTE, or a relay station or access point, or a vehicle-mounted device, a wearable device, and a network device (gNB) in an NR network, or a network device in a future evolved PLMN network, or a network device in an NTN network, etc.

By way of example and not limitation, in the embodiments of the present application, the network device may have a mobile characteristic. For example, the network device may be mobile equipment. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station set up on land, water, or the like.

In the embodiments of the present application, the network device may provide services for a cell, and the terminal device may communicate with the network device through transmission resources (e.g., frequency domain resources, or spectrum resources) used by the cell. The cell may be a cell corresponding to the network device (e.g., a base station). The cell may belong to a macro base station or a base station corresponding to a small cell. The small cell here may include: a metro cell, a micro cell, a pico cell, a femto cell, etc. These small cells have characteristics of small coverage and low transmission power, and are suitable for providing high-speed data transmission services.

For example, FIG. 1 illustrates a communication system 100. The communication system includes a network device 110 and two terminal devices 120. In an implementation, the communication system 100 may include multiple network devices 110, and there are another number of terminal devices 120 in a coverage area of each network device 110, which is not limited in the embodiments of the present application.

In an implementation, the communication system 100 may further include other network entities such as a Mobility Management Entity (MME) and an Access and Mobility Management Function (AMF), which is not limited in the embodiments of the present application.

The network device may include an access network device and a core network device. That is, the wireless communication system further includes multiple core networks for communicating with the access network device. The access network device may be an evolutional base station (evolutional node B, eNB or e-NodeB), a macro base station, a micro base station (also called a "small base station"), a pico base station, an access point (AP), a transmission point (TP) or a new generation Node B (gNodeB), etc. in a long-term evolution (LTE) system, a next-generation (mobile communication system) (next radio, NR) system or an authorized auxiliary access long-term evolution (LAA-LTE) system.

It should be understood that a device in a network/system having a communication function in the embodiments of the present application may be referred to as a communication device. In an example of the communication system shown in FIG. 1, the communication devices may include the network device and the terminal devices, which have the communication function. The network device and the terminal devices may be specific devices in the embodiments of the present application. The communication devices may also include other devices in the communication system, such as a network controller, a mobile management entity and other network entities, which are not limited to the embodiments of the present application.

It should be understood that terms "system" and "network" are often used interchangeably herein. The term "and/or" herein is used to describe an association relationship between associated objects, for example, to indicate that there may be three relationships between the related objects. For example, "A and/or B" may represent: A exists alone, A and B exist at the same time and B exists alone. In addition, the character "/" herein generally indicates that related objects before and after this character are in an "or" relationship.

It should be understood that the "indicate" mentioned in the embodiments of the present application may mean a direct indication or an indirect indication, or represent that there is an association relationship. For example, A indicating B may mean that A directly indicates B, e.g., that B may be obtained through A; or it may mean that A indirectly indicates B, e.g., that A indicates C, and B may be obtained through C; or it may mean that there is an association relationship between A and B.

The term "correspond" described in the embodiments of the present application may mean a relationship of direct or indirect correspondence between the two, or a relationship of association between the two, or a relationship of indicating and being indicated, or configuring and being configured, or the like.

To facilitate understanding of the technical solutions in the embodiments of the present application, related technologies of the present application are described in below. The following related technologies, as optional solutions, may be arbitrarily combined with the technical solutions in the embodiments of the present application, and those combined solutions all belong to protection scope of the embodiments of the present application.

The uplink and downlink collaboration in the prior art only involves the scenario of a single UE. For a single UE scenario, both an uplink data flow and a downlink data flow of the same service are carried in the same PDU session.

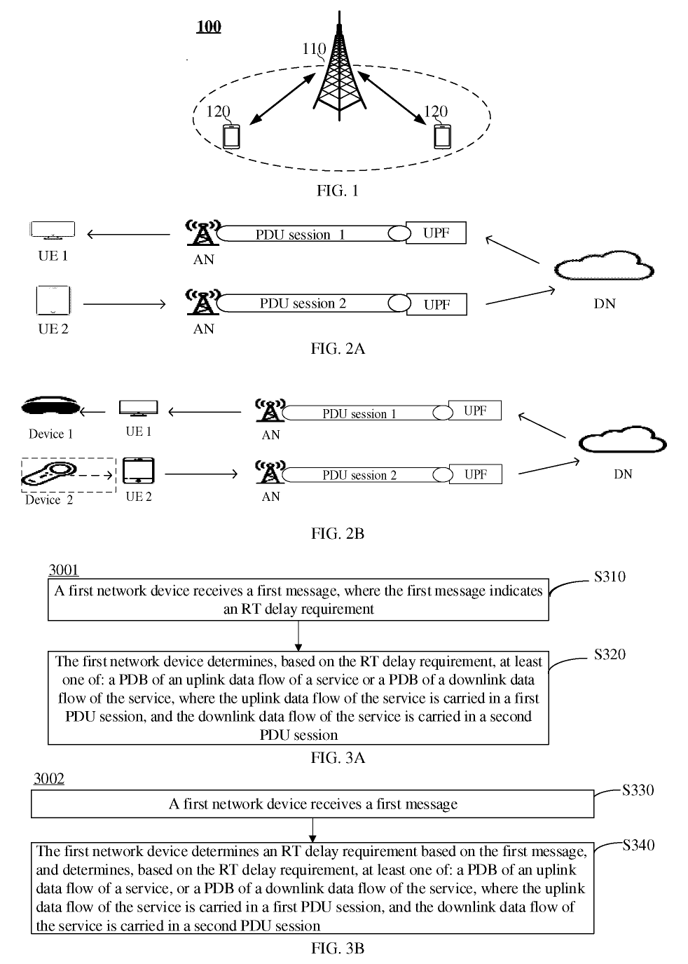

FIGS. 2A and 2B illustrate a multi-UE scenario, that is, the uplink data flow and downlink data flow of the same service are carried in different PDU sessions of different UEs. As illustrated in FIGS. 2A and 2B, the uplink data flow and the downlink data flow belonging to the same service are carried in different PDU sessions, where the uplink data flow is carried in a PDU session 2 of UE 2 and the downlink data flow is carried in a PDU session 1 of UE 1. In FIG. 2B, UE 1 and UE 2 are further connected to tethered devices respectively. For example, in FIG. 2B, UE 1 is connected to a device 1 and UE 2 is connected to a device 2, and UE 1 and/or UE 2 offloads part of the service flow to its tethered device.

In a multi-UE scenario, uplink and downlink data flows are carried in different PDU sessions. In this case, it is necessary to solve the problem of data flow association across terminals and PDU sessions. That is, it is necessary to determine which data flows of different PDU sessions carried by different UEs belong to the same service, and allocate packet delay budgets (PDBs) for the uplink data flow and downlink data flow belonging to the same service respectively, and ensure that a sum of the allocated PDBs for the uplink data flow and the downlink data flow does not exceed the RT delay requirement.

In scenarios where part of the service flow is offloaded by the UE to the tethered device of the UE, such as a smartphone offloading audio flows to a Bluetooth headset, the RT delay requirement of the application function (AF) includes the delay between the smartphone and the Bluetooth headset, while the PDB is a delay budget between the UE and the user plane function (UPF). In the existing uplink and downlink collaboration control, when the PCF determines the PDB of the uplink data flow and the PDB of the downlink data flow, if the delay between the UE and the tethered device of the UE is not considered, the allocated PDB value may be too high.

In addition, existing Quality of Service (QoS) monitoring mechanisms can only monitor a round-trip packet delay within the same PDU session, but cannot measure the round-trip packet delay when the uplink and downlink data flows of the same service are carried in different PDU sessions of different UEs.

FIG. 3A is a schematic flowchart of a configuration method 3001 according to an embodiment of the present application. This method may optionally be applied to the system illustrated in FIG. 1, FIG. 2A or FIG. 2B, but is not limited thereto. The method includes at least part of the following.

S310: a first network device receives a first message, where the first message indicates an RT delay requirement.

S320: the first network device determines, based on the RT delay requirement, at least one of: a PDB of an uplink data flow of a service, or a PDB of a downlink data flow of the service.

The uplink data flow of the service is carried in a first PDU session, and the downlink data flow of the service is carried in a second PDU session.

FIG. 3B is a schematic flowchart of a configuration method 3002 according to an embodiment of the present application. This method may optionally be applied to the system illustrated in FIG. 1, FIG. 2A or FIG. 2B, but is not limited thereto. The method includes at least part of the following.

S330: a first network device receives a first message.

S340: the first network device determines an RT delay requirement based on the first message, and determines, based on the RT delay requirement, at least one of: a PDB of an uplink data flow of a service, or a PDB of a downlink data flow of the service.

The uplink data flow of the service is carried in a first PDU session, and the downlink data flow of the service is carried in a second PDU session.

FIG. 3C is a schematic flowchart of a configuration method 3003 according to an embodiment of the present application. This method may optionally be applied to the system shown in FIG. 1, FIG. 2A or FIG. 2B, but is not limited thereto. The method includes at least part of the following.

S350: a first network device receives a first message.

S360: the first network device determines, based on the first message, at least one of: a PDB of an uplink data flow of a service, or a PDB of a downlink data flow of the service.

The uplink data flow of the service is carried in a first PDU session, and the downlink data flow of the service is carried in a second PDU session.

It should be noted that the "first" and "second" in the above-mentioned first PDU session and second PDU session are only used to distinguish two different PDU sessions, that is, the uplink data flow and downlink data flow of the same service are carried in two different PDU sessions respectively, and these two different PDU sessions correspond to different UEs. "First" and "second" do not imply order or other meanings such as importance.

The data flow in the embodiments of the present application may also be referred to as a service flow, a service data flow (SDF), a QoS flow carrying a data flow, or a QoS flow carrying an SDF, etc.

Based on the RT delay requirement or the first message, the first network device allocates PDBs for the uplink data flow and the downlink data flow belonging to the same service and carried in different PDU sessions of different UEs, thereby realizing uplink and downlink collaboration in a multi-UE scenario, thereby realizing uplink and downlink link policy control based on the RT delay requirement. The first network device allocates a corresponding PDB for the uplink data flow and allocates a corresponding PDB for the downlink data flow.

In some implementations, the first network device may generate a corresponding policy and charging control (PCC) rule for the uplink data flow and the downlink data flow, respectively, and assign a 5G QoS Identifier (5QI) to the corresponding PCC rule based on the obtained PDB of the uplink data flow and the PDB of the downlink data flow.

In some implementations, the first PDU session and the second PDU session may be served by the same policy control function (PCF). In this case, the first network device may be the PCF. As a central node, PCF first determines the uplink data flow and downlink data flow belonging to the same service, and then dynamically configures PDBs for the uplink data flow and downlink data flow belonging to the same service based on the RT delay requirement. The PDB of the uplink data flow may be referred to as an uplink PDB (UL PDB), and the PDB of the downlink data flow may be referred to as a downlink PDB (DL PDB).

In other implementations, the first PDU session and the second PDU session may be served by different PCFs. In this case, the first network device may be a PCF serving any PDU session (e.g., the first PDU session or the second PDU session), or other network element (e.g., an NEF, BSF, UDR). The PCF serving any PDU session or other network element (e.g., an NEF) acts as the central node to determine the uplink data flow and the downlink data flow belonging to the same service, and dynamically configure PDBs for the uplink data flow and the downlink data flow belonging to the same service based on the RT delay requirement. The PDB of the uplink data flow may be referred to as the uplink PDB (UL PDB), and the PDB of the downlink data flow may be referred to as the downlink PDB (DL PDB).

In some implementations, the first message may carry at least one of: a one-way delay requirement; an uplink and downlink collaboration indication; an AF identifier; information used to determine a PDU session carrying the service; information used to determine the uplink data flow and/or the downlink data flow; information used to assist the first network device in adjusting the uplink PDB and the downlink PDB; an alternative parameter; a QoS monitoring requirement; a correlation identifier; address(es) and/or identifier(s) of other first network device(s) at a peer side; a one-way packet delay obtained by QoS monitoring; or information of a tethered device of a UE.

The one-way delay requirement may include a delay requirement between a UE and a UPF. For example, a one-way delay requirement between the UE and the UPF, or an uplink delay requirement and a downlink delay requirement between the UE and the UPF.

The uplink and downlink collaboration indication may indicate the first network device to allocate a corresponding PDB for the uplink data flow of the session, and allocate a corresponding PDB for the downlink data flow of the session; for example, the uplink and downlink collaboration indication indicates the first network device to allocate, based on the RT delay requirement, a corresponding PDB for the uplink data flow of the session, and allocate, based on the RT delay requirement, a corresponding PDB for the downlink data flow of the session.

The information of the tethered device of the UE may include at least one of: an address of the device, an identifier of the device, or a correlation relationship between the tethered device and the UE.

If the first message carries a one-way delay requirement, the first network device may calculate the RT delay requirement based on the one-way delay requirement according to the uplink and downlink collaboration indication, for example, it is determined that the RT delay requirement is equal to twice the one-way delay requirement. Alternatively, if the first message carries two one-way delay requirements, including an uplink delay requirement and a downlink delay requirement, the first network device may calculate the RT delay requirement based on the two one-way delay requirements according to the uplink and downlink collaboration indication, for example, it is determined that the RT delay requirement is equal to a sum of the uplink delay requirement and the downlink delay requirement.

The functions of the uplink and downlink collaboration indication include at least one of: indicating to determine the RT delay requirement using the one-way delay requirement; indicating to determine, based on the RT delay requirement, the PDB for the uplink data flow of the service and/or the PDB for the downlink data flow of the service; or carrying the RT delay requirement.

If the first message carries the RT delay requirement, the RT delay requirement may be considered as an implicit uplink and downlink collaboration indication; that is, if the first message carries the RT delay requirement, it indicates to determine the PDB for the uplink data flow of the service and/or the PDB for the downlink data flow of the service based on the RT delay requirement.

In some implementations, the information used to determine the PDU session carrying the service includes at least one of: an address of the UE, an identifier of the UE, a data network name (DNN), or single network slice selection assistance information (S-NSSAI).

The first network device may use the correlation identifier to associate data flows carried by different PDU sessions, or determine the association between different PDU sessions where the uplink and downlink QoS flows are located through the correspondence between the same DNN/S-NSSAI and multiple addresses of the UEs and identifiers of the UEs.

The address of the UE may include: an address of a UE corresponding to the first PDU session and/or an address of a UE corresponding to the second PDU session. Based on this information, the first network device can determine that the first PDU session and the second PDU session have a correlation relationship. For example, if the first message carries two addresses of UEs, the first network device can determine that the PDU sessions corresponding to the two addresses of the UEs have the correlation relationship, that is, the two PDU sessions respectively carry the uplink data flow and the downlink data flow belonging to the same service.

In some implementations, the information used to determine the uplink data flow and/or the downlink data flow may include flow description information of the uplink data flow and/or flow description information of the downlink data flow. The flow description information may include at least one of: a source IP address, a destination IP address, a source port number, a destination port number, or protocol information of the data flow.

The first network device may determine that the uplink data flow and the downlink data flow belong to the same service based on the correlation relationship between the first PDU session and the second PDU session (the correlation relationship may be determined based on the information used to determine the PDU session carrying the service carried in the first message), the flow description information of the uplink data flow and the flow description information of the downlink data flow.

For example, the first message includes two UE addresses, including the address of UE 1 and the address of UE 2, which means that a PDU session corresponding to UE 1 and a PDU session corresponding to UE 2 are PDU sessions carrying the uplink data flow and downlink data flow of the same service, or the PDU session corresponding to UE 1 and the PDU session corresponding to UE 2 have a correlation relationship. Furthermore, the first message includes two flow description information, including flow description information 1 and flow description information 2, which means that the data flow corresponding to the flow description information 1 (referred to as data flow 1) and the data flow corresponding to the flow description information 2 (referred to as data flow 2) belong to the same service. Based on the address of UE 1 and the address of UE 2, the first network device may determine two PDU sessions with a correlation relationship, and the two PDU sessions respectively carry the uplink data flow and downlink data flow of the same service; then according to the flow description information 1 and the flow description information 2, the first network device may respectively determine the data flow 1 and the data flow 2 from data flows carried by the two PDU sessions. For example, the data flow 1 may be determined from the data flow carried by one of the PDU sessions, and the data flow 2 may be determined from the data flow carried by the other PDU session; the data flow 1 and the data flow 2 are the uplink data flow and downlink data flow belonging to the same service.

In the above examples, the first message uses an implicit indication method to indicate two data flows with the correlation relationship, that is, to indicate the uplink data flow and the downlink data flow belonging to the same service.

In other examples, the embodiments of the present application may use an explicit indication method to indicate two data flows with the correlation relationship. For example, the first message carries the correlation identifier, which is used to indicate that two data flows with the same correlation identifier need to perform uplink and downlink collaboration, that is, to indicate that the two data flows with the same correlation identifier are the uplink data flow and the downlink data flow belonging to the same service. For example, the correlation identifier may be identifier information such as a correlation ID and a group ID.

In this case, the first network device may determine, based on the correlation identifier, that the two data flows with the same correlation identifier are the uplink data flow and the downlink data flow belonging to the same service.

Taking the first PDU session and the second PDU session being served by the same PCF and the first network device being the PCF as an example, the first message received by the first network device may carry at least one of: a one-way delay requirement; an uplink and downlink collaboration indication; an AF identifier; information used to determine the PDU session carrying the service; information used to determine the uplink data flow and/or the downlink data flow; information used to assist the first network device in adjusting the uplink PDB and the downlink PDB; an alternative parameter; a QoS monitoring requirement; or information of the tethered device of the UE.

The information of the tethered device of the UE may include at least one of: a device address, a device identifier, or a correlation relationship between the tethered device and the UE.

The first network device determines, by using the first message, the uplink data flow and the downlink data flow belonging to the same service. After determining the uplink data flow and the downlink data flow belonging to the same service, the first network device may determine, based on the RT delay requirement, the PDB of the uplink data flow and the PDB of the downlink data flow belonging to the same service. For example, the first network device may determine the PDB of the uplink data flow and the PDB of the downlink data flow belonging to the same service based on at least one of: the RT delay requirement, a packet delay of the uplink data flow, a packet delay of the downlink data flow, or a packet delay between the UE and the tethered device.

For example, the first network device may initiate QoS monitoring, to obtain the packet delay of the uplink data flow, the packet delay of the downlink data flow, and the packet delay between the UE and the tethered device.

Alternatively, the first network device may initiate QoS monitoring, to obtain the packet delay of the uplink data flow and the packet delay of the downlink data flow; and the first network device transmits a delay request to a UE related to the uplink data flow and/or a UE related to the downlink data flow, and receives the packet delay between the UE and the tethered device from the UE related to the uplink data flow and/or the UE related to the downlink data flow.

In an example, the first network device determining, based on the RT delay requirement, at least one of: the PDB of the uplink data flow, or the PDB of the downlink data flow of the service may include: determining, by the first network device, at least one of: the PDB of the uplink data flow, or the PDB of the downlink data flow of the service, based on the RT delay requirement, the packet delay of the uplink data flow, and the packet delay of the downlink data flow.

For example, the PDB of the uplink data flow and the PDB of the downlink data flow determined by the first network device may meet a following requirement: a sum of the PDB of the uplink data flow and the PDB of the downlink data flow being less than or equal to the RT delay requirement.

In this example, the packet delay of the uplink data flow and the packet delay of the downlink data flow may be used as reference data when the first terminal device determines the PDB of the uplink data flow and the PDB of the downlink data flow.

In an example, if the UE is further connected to a tethered device, the first network device determining, based on the RT delay requirement, at least one of: the PDB of the uplink data flow, or the PDB of the downlink data flow of the service may include: determining, by the first network device, at least one of: the PDB of the uplink data flow, or the PDB of the downlink data flow of the service, based on the RT delay requirement and the packet delay between the UE and the tethered device; or determining, by the first network device, at least one of: the PDB of the uplink data flow, or the PDB of the downlink data flow of the service, based on the RT delay requirement, the packet delay of the uplink data flow, the packet delay of the downlink data flow, and the packet delay between the UE and the tethered device.

For example, the PDB of the uplink data flow and the PDB of the downlink data flow determined by the first network device may meet the following requirement: a sum of the PDB of the uplink data flow and the PDB of the downlink data flow being less than or equal to a first delay requirement, the first delay requirement being equal to the RT delay requirement minus the packet delay between the UE and the tethered device.

In this example, the packet delay of the uplink data flow and the packet delay of the downlink data flow may be used as reference data when the first terminal device determines the PDB of the uplink data flow and the PDB of the downlink data flow.

In some implementations, the alternative parameter in the first message may include: an alternative RT delay requirement, or a parameter used to determine the alternative RT delay requirement.

In a case where at least one of: the PDB of the uplink data flow of the service, or the PDB of the downlink data flow of the service cannot be determined by the first network device based on the RT delay requirement, the first network device may determine, based on the alternative RT delay requirement, at least one of: the PDB of the uplink data flow of the service, or the PDB of the downlink data flow of the service.

For example, if the RT delay requirement cannot be met by adjusting the PDB of the uplink data flow and the PDB of the downlink data flow by the first network device (e.g., PCF), for example, a sum of the packet delay of the uplink data flow and the packet delay of the downlink data flow measured by QoS monitoring (equal to the round-trip packet delay) is greater than the RT delay requirement of the AF, the first network device (e.g., PCF) may notify the AF that the uplink and downlink collaboration has failed. If the AF carries the alternative RT delay requirement in the first message, the PCF may adjust the PDB of the uplink data flow and the PDB of the downlink data flow according to the alternative RT delay requirement, for example, making the sum of the adjusted PDB of the uplink data flow and the adjusted PDB of the downlink data flow less than or equal to the alternative RT delay requirement, and notify the AF that the alternative RT delay requirement is enabled.

Taking the first PDU session and the second PDU session being served by different PCFs, and the first network device being the PCF serving the first PDU session or the PCF serving the second PDU session as an example, the first message may carry at least one of: a one-way delay requirement; an uplink and downlink collaboration indication; information used to determine the PDU session carrying the service; information used to determine the uplink data flow and/or the downlink data flow; information used to assist the first network device in adjusting the uplink PDB and the downlink PDB; a correlation identifier; address(es) and/or identifier(s) of other first network device(s) at a peer side; a one-way packet delay obtained by QoS monitoring; or information of the tethered device of the UE.

The information of the tethered device of the UE may include at least one of: an address of the device, an identifier of the device, or a correlation relationship between the tethered device and the UE.

The first message may further carry at least one of: the PDB of the uplink data flow, or the PDB of the downlink data flow determined by other first network device(s).

The first message may be a message transmitted from one of the PCF serving the first PDU session and the PCF serving the second PDU session to another. For example, in a case where the first PDU session and the second PDU session are served by different PCFs, the PCF serving the first PDU session may transmit the first message to the PCF serving the second PDU session, where the first message carries an address and/or identifier of the PCF serving the first PDU session, and may further carry a PDB of the uplink data flow determined by the PCF serving the first PDU session, and the one-way packet delay (i.e., uplink packet delay) obtained by QoS monitoring; or, the PCF serving the second PDU session may transmit the first message to the PCF serving the first PDU session, where the first message carries an address and/or identifier of the PCF serving the second PDU session, and may further carry a PDB of the downlink data flow determined by the PCF serving the second PDU session, and the one-way packet delay (i.e., downlink packet delay) obtained by QoS monitoring. Before transmitting the first message, the PCF serving the first PDU session and/or the PCF serving the second PDU session may receive relevant information from the AF.

The first network device receiving the first message may determine, according to the first message, the uplink data flow and the downlink data flow belonging to the same service (for the determination method, the above-mentioned related introduction may be referred to), and determine at least one of: the PDB of the uplink data flow, or the PDB of the downlink data flow of the service.

For example, the first network device determines the PDB of the uplink data flow and/or the PDB of the downlink data flow based on at least one of: the RT delay requirement, a PDB of a one-way data flow determined by other first network device(s), the packet delay between the UE and the tethered device, the packet delay of the uplink data flow, or the packet delay of the downlink data flow; where the PDB of the one-way data flow includes the PDB of the uplink data flow or the PDB of the downlink data flow.

In some implementations, after determining the PDB of the uplink data flow and the PDB of the downlink data flow belonging to the same service, the first network device may initiate a session modification process for the first PDU session and/or a session modification process for the second PDU session, to configure a corresponding PDB for the uplink data flow and/or a corresponding PDB for the downlink data flow.

In some implementations, the QoS monitoring requirement in the first message may indicate at least one of: a parameter that needs to be measured for QoS monitoring; a target network element to which a QoS monitoring result is reported; or a condition for reporting the QoS monitoring result.

The parameter that needs to be measured for QoS monitoring may include at least one of: a packet delay of the uplink data flow, a packet delay of the downlink data flow, or a round-trip packet delay. The round-trip packet delay includes a round-trip packet delay of the service whose uplink data flow and downlink data flow are carried in different PDU sessions respectively.

In some implementations, the first network device may further report the QoS monitoring result based on the QoS monitoring requirement, where the QoS monitoring result includes at least one of: a packet delay uplink of the data flow, a packet delay of the downlink data flow, or a round-trip packet delay.

For example, the round-trip packet delay reported by the first network device may be determined based on at least one of: the packet delay of the uplink data flow, the packet delay of the downlink data flow, or a packet delay between the UE and the tethered device.

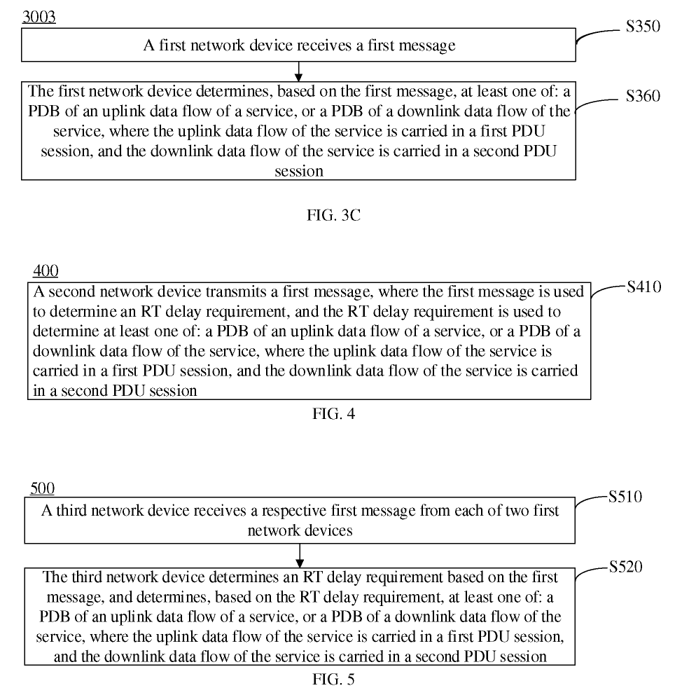

The embodiments of the present application further provide a configuration method. FIG. 4 is a schematic flowchart of a configuration method 400 according to an embodiment of the present application. This method may optionally be applied to the system illustrated in FIG. 1, FIG. 2A or FIG. 2B, but is not limited thereto. The method includes at least part of the following.

S410: a second network device transmits a first message, where the first message is used to determine an RT delay requirement, and the RT delay requirement is used to determine at least one of: a PDB of an uplink data flow of a service, or a PDB of a downlink data flow of the service.

The uplink data flow of the service is carried in a first PDU session, and the downlink data flow of the service is carried in a second PDU session.

In some implementations, the second network device may include an AF, and a first network device may include a PCF. For example, the PCF may be a PCF serving the first PDU session and the second PDU session, or a PCF serving the first PDU session, or a PCF serving the second PDU session.

The first message may carry at least one of: a one-way delay requirement; an uplink and downlink collaboration indication; an AF identifier; information used to determine a PDU session carrying the service; information used to determine the uplink data flow and/or the downlink data flow; information used to assist a first network device in adjusting the uplink PDB and the downlink PDB; an alternative parameter; a QoS monitoring requirement; a correlation identifier; address(es) and/or identifier(s) of other first network device(s) at a peer side; a one-way packet delay obtained by QoS monitoring; or information of a tethered device of user equipment.

For the content carried in the first message and the manner in which the first network device determines the PDB of the uplink data flow and the PDB of the downlink data flow according to the first message, the relevant contents of the above embodiments may be referred to and will not be repeated here.

If the first PDU session and the second PDU session are served by the same PCF, the AF transmits the first message to the PCF.

In a case where the first PDU session and the second PDU session are served by different PCFs, the AF transmits the first message to the PCF serving the first PDU session and the PCF serving the second PDU session respectively. The PCF serving the first PDU session and the PCF serving the second PDU session may negotiate to determine the PDB of the uplink data flow and/or the PDB of the downlink data flow of the service, or transmit relevant information in the first message to a central node, which determines an RT delay requirement based on the received information, and determines, based on the RT delay requirement, at least one of: the PDB of the uplink data flow of the service, or the PDB of the downlink data flow of the service.

For example, the central node is a third network device, and the embodiments of the present application further provide a configuration method, which is applied to the third network device. FIG. 5 is a schematic flowchart of a configuration method 500 according to an embodiment of the present application. This method may optionally be applied to the system shown in FIG. 1, FIG. 2A or FIG. 2B, but is not limited thereto. The method includes at least part of the following.

S510: the third network device receives a respective first message from each of two first network devices.

S520: the third network device determines an RT delay requirement based on the first message, and determines, based on the RT delay requirement, at least one of: a PDB of an uplink data flow of a service, or a PDB of a downlink data flow of the service.

The uplink data flow of the service is carried in a first PDU session, and the downlink data flow of the service is carried in a second PDU session.

In some implementations, the first message carries at least one of: a one-way delay requirement; an uplink and downlink collaboration indication; information used to determine a PDU session carrying the service; information used to determine the uplink data flow and/or the downlink data flow; information used to assist the first network device in adjusting the uplink PDB and downlink PDB; an alternative parameter; a QoS monitoring requirement; a correlation identifier; address(es) and/or identifier(s) of other first network device(s) at a peer side; a one-way packet delay obtained by monitoring; or information of a tethered device of a UE.

Function of the uplink and downlink collaboration indication may include at least one of: indicating to determine the RT delay requirement using the one-way delay requirement; indicating to determine, based on the RT delay requirement, the PDB for the uplink data flow of the service and/or the PDB for the downlink data flow of the service; or carrying the RT delay requirement.

For the content carried in the first message, reference may be made to the relevant content of the first message received by the first network device in the aforementioned implementations.

In some implementations, the third network device includes a network element function (NEF), a binding support function (BSF) or a unified data repository (UDR) function, and the first network device includes a PCF. The NEF, BSF or UDR acts as a central node, receives the first message from the PCF serving the first PDU session and receives the first message from the PCF serving the second PDU session respectively, and determines the uplink data flow and downlink data flow belonging to the same service based on the first message, and allocates PDBs for the uplink data flow carried by the first PDU session and the downlink data flow carried by the second PDU session. For the manner in which the third network device determines the uplink data flow and downlink data flow belonging to the same service, and the manner of allocating the PDBs for the uplink data flow and downlink data flow belonging to the same service, the relevant contents in the aforementioned embodiments may be referred to and will not be repeated here.

After allocating the PDBs for the uplink data flow and the downlink data flow, the third network device may transmit a respective second message to each of the two first network devices. The second message may carry at least one of: an uplink and downlink collaboration indication; the PDB of the uplink data flow or the PDB of the downlink data flow; a correlation identifier; a DNN; S-NSSAI; or the RT delay requirement.

The two first network devices (e.g., the PCF serving the first PDU session and the PCF serving the second PDU session) may initiate, based on the received second message, a session modification process for the first PDU session and/or a session modification process for the second PDU session, and configure a corresponding PDB for the uplink data flow and/or a corresponding PDB for the downlink data flow.

For example, the PCF serving the first PDU session receives the second message from the third network device, and the second message carries the PDB of the uplink data flow allocated by the third network device. The PCF serving the first PDU session may initiate the session modification process for the first PDU session and configure the corresponding PDB for the uplink data flow. In addition, the PCF serving the second PDU session receives the second message from the third network device, and the second message carries the PDB of the downlink data flow allocated by the third network device. The PCF serving the second PDU session may initiate the session modification process for the second PDU session and configure the corresponding PDB for the downlink data flow.

With reference to the accompanying drawings and using exemplary embodiments, the configuration method provided in the present application is described in detail. The configuration method provided in the present application may achieve uplink and downlink collaboration in a multi-UE scenario.

### Embodiment I:

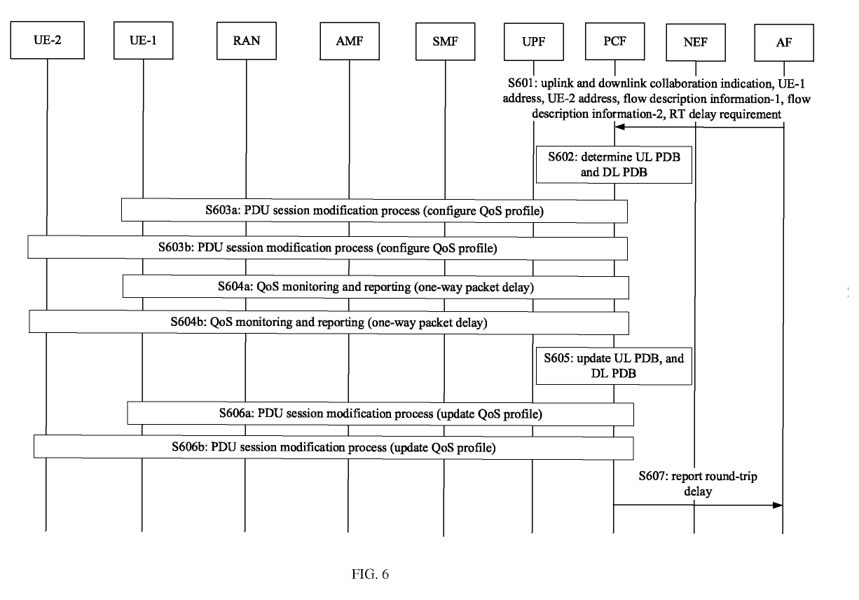

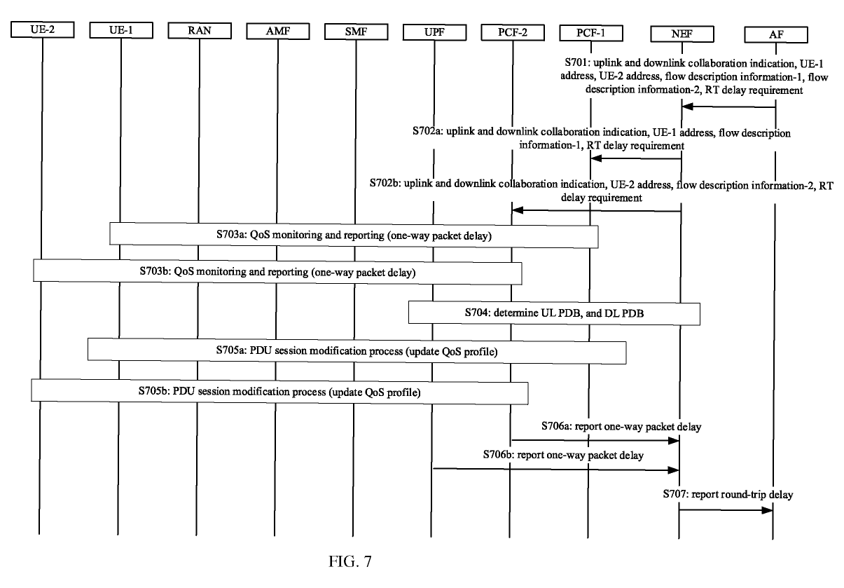

In this embodiment, PCFs serving two PDU sessions of two UEs are the same PCF. The PCF may serve as a central node for uplink and downlink collaboration control. The PCF may determine, based on an AF request, a PDB of an uplink data flow and a PDB of a downlink data flow belonging to the same service in the two PDU sessions. In the application scenario involved in this embodiment, a UE-1 requests to establish a PDU session, a network side selects a UPF-1 as an anchor UPF (PDU session anchor (PSA) UPF), and the PDU session carries the uplink data flow (or the downlink data flow) of the service; a UE-2 requests to establish a PDU session, a network side selects a UPF-2 as an anchor UPF, and the PDU session carries the downlink data flow (or the uplink data flow) of the service. The UPF-1 and the UPF-2 may be the same UPF, or may be different UPFs. In this embodiment, the data flow may also be referred to as a QoS flow, an SDF flow, a service flow, etc. FIG. 6 is a flowchart of an implementation of Embodiment I of the present application, including the following operations.

S601: the AF directly requests the PCF to perform uplink and downlink collaboration control, or the AF requests the PCF to perform uplink and downlink collaboration control through an NEF. A request message transmitted by the AF to the PCF or the NEF may carry at least one of the following parameters: (I) an uplink and downlink collaboration indication: used to indicate the PCF to determine, based on an RT delay requirement, PDBs for the uplink and downlink QoS flows of a target service; (II) an AF identifier; (III) information used to determine a PDU session carrying the target service, which may include at least one of: 1. a group of UE addresses, e.g., a UE-1 address and a UE-2 address; 2. a group of UE identifiers, e.g., a general public subscription identifier (GPSI) of the UE-1 and an external GPSI of the UE-2; or external group identifier information of the UE-1 and the UE 2; 3. a DNN; or 4. S-NSSAI; (IV) information used to determine a target QoS flow (or SDF flow), which may include: a set of flow description information, which may include two flow description information corresponding to the uplink data flow and the downlink data flow respectively; where the flow description information may include a source IP address, a destination IP address, a source port number, a destination port number, and protocol information; (V) information used to provide the RT delay requirement, which may include at least one of: 1. a one-way delay requirement: i.e., the AF provides both uplink and downlink delay requirements, and the RT delay requirement = the uplink delay requirement + the downlink delay requirement; or, the AF provides the one-way delay requirement, and the RT delay requirement is twice the one-way delay requirement; or 2. the RT delay requirement; (VI) information used to assist the PCF in adjusting the uplink PDB and the downlink PDB, which may include at least one of: 1. a period of QoS adjustment: a period of adjusting the PDB of the uplink data flow (also known as UL PDB) and the PDB of the downlink data flow (also known as DL PDB). For example, QoS monitoring is performed on the QoS flow every 20 minutes, and the UL PDB and DL PDB are updated based on a QoS monitoring result; or 2. a threshold of QoS adjustment: when a difference between the QoS monitoring result and the current PDB reaches a set threshold of QoS adjustment, the update of the UL PDB and the DL PDB is triggered; (VII) an alternative parameter, which may include at least one of: 1. an alternative QoS parameter: if the current QoS cannot be met, the access network device may use the alternative QoS parameter and notify the PCF and AF of the alternative QoS parameter, etc.; or 2. an alternative RT delay requirement: if the current RT delay requirement cannot be met, for example, when a round-trip packet delay measured by QoS monitoring is much greater than the current RT delay requirement, the PCF may use the alternative RT delay requirement to re-determine the UL PDB and DL PDB, where the alternative RT requirement may be provided by the AF as a separate parameter in the request message, or may be calculated by the PCF based on the alternative QoS parameter; (VIII) a QoS monitoring requirement, which may include at least one of: 1. a parameter that needs to be measured; 2. a target network element to which a QoS monitoring result is reported; or 3. a condition for reporting the QoS monitoring result, e.g., periodic reporting or reporting when a predetermined threshold is reached; where the parameter that needs to be measured may include at least one of: a packet delay of the uplink data flow, a packet delay of the downlink data flow, or a round-trip packet delay, where the round-trip packet delay includes a round-trip packet delay of the service whose uplink data flow and downlink data flow are carried in different PDU sessions respectively.

The NEF is responsible for discovering the PCF that serves a PDU session, and the PDU session corresponds to a UE address carried in the request message. After discovering the PCF serving the PDU session, the NEF forwards the request message to the PCF.

S602: the PCF determines the PDB for the uplink QoS flow and the PDB for the downlink QoS flow based on the RT delay requirement indicated by the request message. For example, the PCF may acquire the RT delay requirement directly from the request message, or determine the RT delay requirement based on the one-way delay requirement carried in the request message (RT delay requirement = one-way delay requirement × 2, or RT delay requirement = uplink delay requirement + downlink delay requirement).

For example, a sum of the PDB determined by the PCF for the uplink QoS flow and the PDB determined for the downlink QoS flow may be less than or equal to the RT delay requirement.

S603: the PCF initiates a PDU session modification process for the UE-1 and the UE-2 respectively. For example, the PCF configures QoS profiles for the UL QoS flow and the DL QoS flow respectively, and the two QoS profiles respectively include the UL PDB and DL PDB determined by the PCF.

S604: the PCF initiates QoS monitoring respectively for the UL QoS flow and DL QoS flow in the PDU sessions corresponding to the UE-1 address and UE-2 address, based on local configuration or a period of the QoS adjustment provided by the AF, and monitors the packet delay of the two QoS flows. For example, the PCF initiates QoS monitoring on the uplink QoS flow of the PDU session of the UE-1 and obtains the one-way packet delay, e.g., the packet delay of the uplink QoS flow (which may be referred to as the uplink packet delay). Furthermore, the PCF initiates QoS monitoring on the downlink QoS flow of the PDU session of the UE-2 and obtains the one-way packet delay, e.g., the packet delay of the downlink QoS flow (which may be referred to as the downlink packet delay).

S605: the PCF updates, based on the QoS monitoring result, the PDB of the uplink QoS flow and the PDB of the downlink QoS flow. The PCF determines, based on the local configuration and the period of the QoS adjustment and/or the threshold of the QoS adjustment provided by the AF, whether the PDB of the uplink QoS flow and the PDB of the downlink QoS flow need to be updated. For example, if the RT delay requirement cannot be met by adjusting, by the PCF, the PDB of the uplink QoS flow and the PDB of the downlink QoS flow, for example, a sum of the packet delay of the uplink data flow (which may be called UL packet delay) and the packet delay of the downlink data flow (which may be called DL packet delay) measured by QoS monitoring is greater than the RT delay requirement of the AF, then the PCF may notify the AF that the uplink and downlink collaboration has failed. If the AF provides the alternative RT delay requirement in the request message, the PCF may adjust, based on the alternative RT delay requirement, a value of the PDB of the uplink QoS flow and a value of the PDB of the downlink QoS flow, and notify the AF that the alternative RT delay requirement is enabled.

S606: the PCF initiates a PDU session modification process for the UE-1 and a PDU session modification process for the UE-2 respectively, and configures the updated QoS profiles for the uplink QoS flow and the downlink QoS flow respectively, where the two QoS profiles include the PDB of the uplink QoS flow and the PDB of the downlink QoS flow respectively.

S607: if the request message transmitted by the AF carries the QoS monitoring requirement, the PCF may report the QoS monitoring result to the AF or the target network element designated by the AF. If the parameter the AF requests to measure is the packet delay of the uplink data flow or the packet delay of the downlink data flow, the PCF may directly report the measurement result of the one-way packet delay (that is, the packet delay of the uplink data flow or the packet delay of the downlink data flow) to the AF; if the parameter the AF requests to measure is a round-trip packet delay, the PCF calculates the round-trip packet delay based on the measurement result of the one-way packet delay and reports the round-trip packet delay to the AF. In addition, as described in an operation S605, in a case where the RT delay requirement cannot be met by adjusting, by the PCF, the UL PDB and the DL PDB, or the alternative RT delay requirement is enabled, the AF will also be notified.

### Embodiment II:

In this embodiment, PCFs serving two PDU sessions of two UEs are two different PCFs. The two PCFs need to collaborate with each other to determine a corresponding PDB for an uplink data flow and a corresponding PDB for a downlink data flow in the different PDU sessions of the two UEs. In the application scenario involved in this embodiment, a UE-1 requests to establish a PDU session, a network side selects a UPF-1 as an anchor UPF, the PDU session carries the uplink data flow (or the downlink data flow) of the service, and a PCF-1 serves the PDU session; a UE-2 requests to establish a PDU session, a network side selects a UPF-2 as an anchor UPF, the PDU session carries the downlink data flow (or the uplink data flow) of the service, and a PCF-2 serves the PDU session. The UPF-1 and the UPF-2 may be the same UPF, or may be different UPFs. In this embodiment, the data flow may also be referred to as a QoS flow, an SDF flow, a service flow, etc. FIG. 7 is a flowchart of an implementation of Embodiment II of the present application, which includes the following operations.

S701: the AF requests to perform uplink and downlink collaboration control, and the AF transmits a request message to an NEF, where the request message may carry at least one of the following parameters: (I) an uplink and downlink collaboration indication: used to indicate the PCF to determine, based on an RT delay requirement, PDBs for the uplink and downlink QoS flows of a target service; (II) an AF identifier; (III) information used to determine a PDU session carrying the target service, which may include at least one of: 1. a group of UE addresses, e.g., a UE-1 address and a UE-2 address; 2. a group of UE identifiers, e.g., a general public subscription identifier (GPSI) of the UE-1 and an external GPSI of the UE-2; or external group identifier information of the UE-1 and the UE 2; 3. a DNN; or 4. S-NSSAI; (IV) information used to determine a target QoS flow (or SDF flow), which may include: a set of flow description information, which may include two flow description information corresponding to the uplink data flow and the downlink data flow respectively; where the flow description information may include a source IP address, a destination IP address, a source port number, a destination port number, and protocol information; (V) information used to provide the RT delay requirement, which may include at least one of: 1. a one-way delay requirement: i.e., the AF provides both uplink and downlink delay requirements, and the RT delay requirement = the uplink delay requirement + the downlink delay requirement; or, the AF provides the one-way delay requirement, and the RT delay requirement is twice the one-way delay requirement; or 2. the RT delay requirement; (VI) information used to assist the PCF in adjusting the uplink PDB and the downlink PDB, which may include at least one of: 1. a period of QoS adjustment: a period of adjusting the PDB of the uplink data flow (also known as UL PDB) and the PDB of the downlink data flow (also known as DL PDB). For example, QoS monitoring is performed on the QoS flow every 20 minutes, and the UL PDB and DL PDB are updated based on a QoS monitoring result; or 2. a threshold of QoS adjustment: when a difference between the QoS monitoring result and the current PDB reaches a set threshold of QoS adjustment, the update of the UL PDB and the DL PDB is triggered; (VII) an alternative parameter, which may include at least one of: 1. an alternative QoS parameter: if the current QoS cannot be met, the access network device may use the alternative QoS parameter and notify the PCF and AF of the alternative QoS parameter, etc.; or 2. an alternative RT delay requirement: if the current RT delay requirement cannot be met, for example, when a round-trip packet delay measured by QoS monitoring is much greater than the current RT delay requirement, the PCF may use the alternative RT delay requirement to re-determine the UL PDB and DL PDB, where the alternative RT requirement may be provided by the AF as a separate parameter in the request message, or may be calculated by the PCF based on the alternative QoS parameter; (VIII) a QoS monitoring requirement, which may include at least one of: 1. a parameter that needs to be measured; 2. a target network element to which a QoS monitoring result is reported; or 3. a condition for reporting the QoS monitoring result, e.g., periodic reporting or reporting when a predetermined threshold is reached; where the parameter that needs to be measured may include at least one of: a packet delay of the uplink data flow, a packet delay of the downlink data flow, or a round-trip packet delay, where the round-trip packet delay includes a round-trip packet delay of the service whose uplink data flow and downlink data flow are carried in different PDU sessions respectively.

S702: the NEF discovers the PCF-1 serving the PDU session of the UE-1 and the PCF-2 serving the PDU session of the UE-2 through a BSF, and transmits a request message to each of the PCF-1 and the PCF-2, which may include the following contents.

(I) The NEF transmits the request message to the PCF-1, where the request message may include at least one of the following parameters: (1) an uplink and downlink collaboration indication: used to indicate to determine, based on an RT delay requirement, the PDBs for the uplink and downlink QoS flows of a target service; (2) a correlation identifier: used to indicate that two QoS flows with the same correlation identifier need to perform uplink and downlink collaboration, where the identifier may be identifier information, e.g., a correlation ID or a group ID; in addition to explicitly indicating that two QoS flows are a pair of QoS flows that require uplink and downlink collaboration through the correlation identifier, the two QoS flows that require uplink and downlink collaboration may also be indicated by carrying two UE addresses, two UE identifiers, two flow description information, two QoS flow identifiers, DNN, or S-NSSAI in the message; (3) an address of the UE-1, e.g., an IP address or MAC address; (4) an identifier of the UE-1, e.g., a subscription permanent identifier (SUPI) or GPSI; (5) a DNN; (6) S-NSSAI; (7) flow description information; (8) an RT delay requirement, which may include the uplink delay requirement and the downlink delay requirement, where RT delay requirement = uplink delay requirement + downlink delay requirement; or, may include a one-way delay requirement, where the RT delay requirement is twice the one-way delay requirement; or, may include the RT delay requirement; (9) an identification or address of the PCF-2; (10) a QoS monitoring requirement; or (11) an alternative parameter.

(II) The NEF transmits the request message to the PCF-2, where the request message may include at least one of the following parameters: (1) an uplink and downlink collaboration indication: used to indicate to determine, based on the RT delay requirement, the PDBs for the uplink and downlink QoS flows of the target service; (2) a correlation identifier: used to indicate that two QoS flows with the same correlation identifier need to perform uplink and downlink collaboration, where identifier may be identifier information, e.g., a correlation ID and a group ID. in addition to explicitly indicating that two QoS flows are a pair of QoS flows that require uplink and downlink collaboration through the correlation identifier, the two QoS flows that require uplink and downlink collaboration may also be indicated by carrying two UE addresses, two UE identifiers, two flow description information, two QoS flow identifiers, DNN, or S-NSSAI in the message; (3) an address of the UE-2, e.g., an IP address or MAC address; (4) an identifier of the UE-2, e.g., an SUPI or GPSI; (5) a DNN; (6) S-NSSAI; (7) flow description information; (8) an RT delay requirement, which may include the uplink delay requirement and the downlink delay requirement, where RT delay requirement = uplink delay requirement + downlink delay requirement; or, may include a one-way delay requirement, where the RT delay requirement is twice the one-way delay requirement; or, may include the RT delay requirement; (9) an identification or address of the PCF-1; (10) a QoS monitoring requirement; or (11) an alternative parameter.

For the detailed introduction to the information carried in the request messages transmitted by the NEF to the PCF-1 and the PCF-2 respectively, please refer to the relevant content of the above-mentioned Embodiment I.

S703: the PCF-1 and the PCF-2 initiate QoS monitoring on the UL QoS flow and downlink QoS flow of the PDU sessions of the UE-1 and the UE-2 respectively to obtain the one-way packet delay. For example, the PCF-1 initiates QoS monitoring on the uplink QoS flow of the PDU session of the UE-1 and obtains the one-way packet delay, e.g., the packet delay of the uplink QoS flow (which may be called the uplink packet delay); and the PCF-2 initiates QoS monitoring on the downlink QoS flow of the PDU session of the UE-2 and obtains the one-way packet delay, e.g., the packet delay of the downlink QoS flow (which may be called the downlink packet delay).

S704: based on the QoS monitoring result, the PCF-1 and the PCF-2 determine the PDB of the uplink QoS flow (which may be called UL PDB) and the PDB of the downlink QoS flow (which may be called DL PDB) by mutual collaboration. Collaboration methods may be classified into the following two types: (1) distributed collaboration: for the process, please refer to Embodiment III; and (2) collaboration based on the central node: for the process, please refer to Embodiment IV.

S705: the PCF-1 initiates a PDU session modification process and the PCF-2 initiate a PDU session modification process respectively. For example, the PCF-1 configures the QoS profile with the updated UL PDB for the QoS flow of the PDU session of the UE-1, and the PCF-2 configures the QoS profile with the updated DL PDB for the QoS flow of PDU session of the UE-2.

S706: if the QoS monitoring requirement in the request message and the AF requests that the result is reported to the AF or the target network function (NF), the PCF-1 and the PCF-2 report the obtained one-way packet delay to the NEF respectively.

S707: if the AF requests the round-trip packet delay monitoring in the request message, the NEF calculates the round-trip packet delay and reports the result to the AF or other target network element. For example, the NEF adds the one-way packet delays received from the PCF-1 and the PCF-2 to obtain the round-trip packet delay.

### Embodiment III:

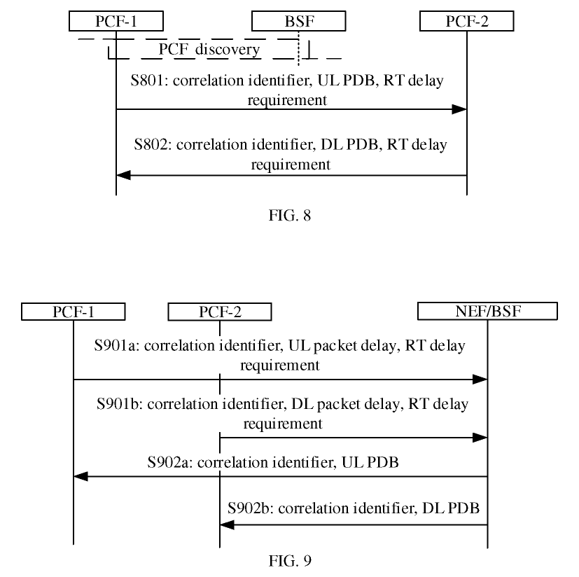

This embodiment is combined with Embodiment II to introduce a method in which a PCF-1 and a PCF-2 determine a PDB of an uplink QoS flow (which may be called UL PDB) and a PDB of a downlink QoS flow (which may be called DL PDB) through a distributed collaboration method. FIG. 8 is a flowchart of an implementation of Embodiment III of the present application. FIG. 8 only illustrates the process of the PCF-1 and the PCF-2 collaborating to determine the UL PDB and DL PDB. For other implementation processes, please refer to the relevant content of Embodiment II. In this embodiment, the PCF-1 may directly interact with the PCF-2 to negotiate the UL PDB and DL PDB, and the two PCFs may determine the UL PDB and DL PDB through a "two-way handshake". As illustrated in FIG. 8, the following operations are included.

S801: the PCF-1 first determines a one-way PDB (UL PDB or DL PDB) based on a QoS monitoring result and a RT delay requirement provided by an AF, and then transmits at least one of the following information to the PCF-2. If the PCF-1 does not have identifier information or address information of the PCF-2, the PCF-2 may be discovered through the BSF. (1) an uplink and downlink collaboration indication; (2) a correlation identifier; (3) a DNN; (4) S-NSSAI; (5) an RT delay requirement; (6) a one-way PDB (UL PDB or DL PDB); (7) flow description information; or (8) a one-way packet delay (measurement result of QoS monitoring).

S802: the PCF-2 determines, based on the correlation identifier, another QoS flow (i.e., the QoS flow of the PDU session corresponding to the UE-2 address) that needs to perform uplink and downlink collaboration with the QoS flow of the PDU session corresponding to the UE-1 address. Based on the UL PDB (or DL PDB), the one-way packet delay, and the RT delay requirement provided by the PCF-1, the DL PDB (or UL PDB) is determined for the QoS flow of the PDU session corresponding to the UE-2 address, and a sum of the UL PDB and DL PDB is ensured not to exceed the RT delay requirement. In addition, the PCF-2 may also re-determine the UL PDB and the DL PDB, based on the one-way packet delay obtained by QoS monitoring provided by the PCF-1, the one-way packet delay obtained by the PCF-2 through QoS monitoring, and the RT delay requirement. After the determination, the PCF-2 transmits at least one of the following information to the PCF-1: (1) an uplink and downlink collaboration indication; (2) a correlation identifier; (3) a DNN; (4) S-NSSAI; (5) an RT delay requirement; or (6) an updated one-way PDB (UL PDB or DL PDB).

Through the above process, the PCF-1 and the PCF-2 negotiate and determine the UL PDB and the DL PDB. In this embodiment, the introduction is made by taking the PCF-1 initiating interaction as an example. In other embodiments of the present application, the interaction may be initiated by the PCF-2.

### Embodiment IV:

This embodiment is combined with Embodiment II to introduce a method of determining the PDB of the uplink QoS flow (which may be called UL PDB) and the PDB of the downlink QoS flow (which may be called DL PDB) based on the central node. FIG. 9 is a flowchart of an implementation of Embodiment IV of the present application. FIG. 9 only illustrates the process of determining the UL PDB and the DL PDB by the central node. For other implementation processes, reference may be made to the relevant contents of Embodiment II. In this embodiment, a core network element, e.g., an NEF, BSF or UDR, is used as the central node to determine the UL PDB and the DL PDB. The PCF-1 and the PCF-2 report their respective QoS monitoring results to the central node, and the central node determines the UL PDB and the DL PDB. The process is as follows.

S901: the PCF-1 and the PCF-2 report the QoS monitoring results to the central node respectively. In this embodiment, the central node includes an NEF or BSF. The content reported by the PCF-1 or the PCF-2 includes at least one of: (1) an uplink and downlink collaboration indication; (2) a correlation identifier; (3) a DNN; (4) S-NSSAI; (5) an RT delay requirement; (6) flow description information; (7) a one-way packet delay (QoS monitoring measurement result); (8) a UE address; or (9) a UE identifier.

For example, if the PCF-1 serves the PDU session of the UE-1, the information reported by the PCF-1 to the central node includes the flow description information and the one-way packet delay of the data flow carried by the PDU session of the UE-1, and the address and/or identifier of the UE-1; if the PCF-2 serves the PDU session of the UE-2, the information reported by the PCF-2 to the central node includes the flow description information and the one-way packet delay of the data flow carried by the PDU session of the UE-2, and the address and/or identifier of the UE-2.

S902: the central node determines the DL PDB and the UL PDB based on the uplink and downlink packet delays reported by the PCF-1 and the PCF-2, the RT delay requirement requested by the AF, and the like. At least one of the following information is transmitted to the PCF-1 and the PCF-2 respectively: (1) an uplink and downlink collaboration indication; (2) a one-way PDB (UL PDB or DL PDB) (3) a correlation identifier; (4) a DNN; (5) S-NSSAI; or (6) an RT delay requirement.

For example, if the PDU session served by the PCF-1 carries the uplink data flow, the information transmitted by the central node to the PCF-1 includes the UL PDB; if the PDU session served by the PCF-2 carries the downlink data flow, the information transmitted by the central node to the PCF-2 includes the DL PDB.

In the above embodiments I to IV, the UE is not connected to a tethered device, so when allocating a PDB for a PDU session between the UE and the UPF, there is no need to consider a packet delay between the UE and the tethered device. If the UE is connected to a tethered device, the packet delay between the UE and the tethered device may be considered when allocating the PDB for the PDU session between the UE and the UPF. The following Embodiment V will introduce this case.

### Embodiment V:

This embodiment is described by taking the PCFs serving two PDU sessions of two UEs being the same PCF as an example. The PCF may serve as the central node for uplink and downlink collaboration control. The PCF may determine, based on the AF request, the PDBs of the uplink data flow and the downlink data flow belonging to the same service in two PDU sessions. In the application scenario involved in this embodiment, the UE-1 requests to establish a PDU session, the network side selects a UPF-1 as the anchor UPF, and the PDU session carries the uplink data flow (or downlink data flow) of the service; the UE-2 requests to establish a PDU session, the network side selects a UPF-2 as the anchor UPF, and the PDU session carries the downlink data flow (or uplink data flow) of the service; at least one of the UE-1 or the UE-2 is connected to the tethered device. The UPF-1 and the UPF-2 may be the same UPF, or may be different UPFs. In this embodiment, the data flow may also be referred to as a QoS flow, an SDF flow, a service flow, etc.

When the UE is connected to the tethered device, the PCF or other central node performing uplink and downlink collaboration may subtract the packet delay between the UE and the tethered device (including a packet delay between the UE-1 and a device-1 and/or a packet delay between the UE-2 and a device-2) from the RT delay requirement provided by the AF, and then obtain a new total delay upper limit; based on the new total delay upper limit, the UL PDB and DL PDB are determined for the uplink and downlink QoS flows, and it is ensured that a sum of the UL PDB and DL PDB does not exceed the new total delay upper limit.

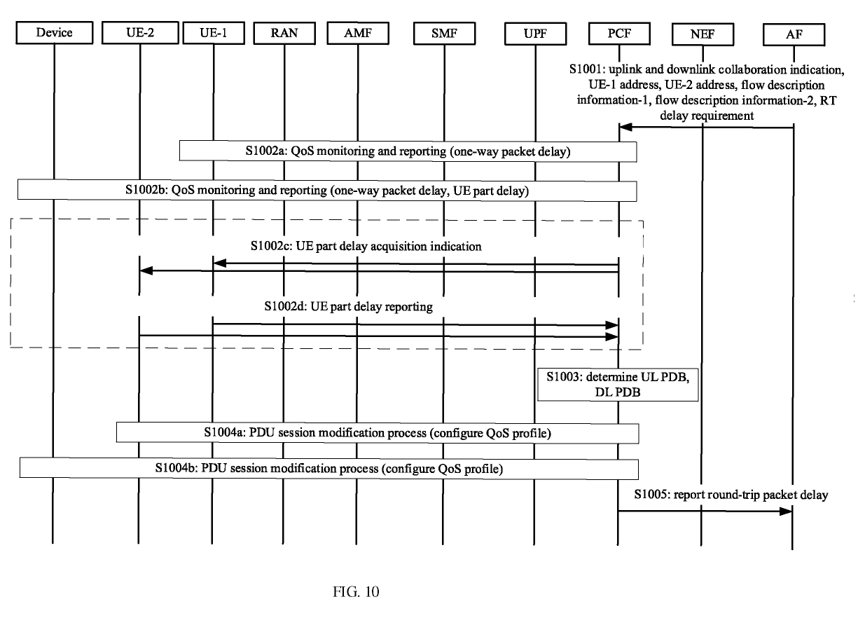

FIG. 10 is a flowchart of an implementation of Embodiment V of the present application, including the following operations.

S1001: the AF directly requests the PCF to perform uplink and downlink collaboration control, or the AF requests the PCF to perform uplink and downlink collaboration control through the NEF. The request message transmitted by the AF to the PCF or NEF may carry at least one of the following parameters: (I) an uplink and downlink collaboration indication: used to indicate the PCF to determine, based on an RT delay requirement, PDBs for the uplink and downlink QoS flows of a target service; (II) an AF identifier; (III) information used to determine a PDU session carrying the target service, which may include at least one of: 1. a group of UE addresses, e.g., a UE-1 address and a UE-2 address; 2. a group of UE identifiers, e.g., a general public subscription identifier (GPSI) of the UE-1 and an external GPSI of the UE-2; or external group identifier information of the UE-1 and the UE 2; 3. a DNN; or 4. S-NSSAI; (IV) information used to determine a target QoS flow (or SDF flow), which may include: a set of flow description information, which may include two flow description information corresponding to the uplink data flow and the downlink data flow respectively; where the flow description information may include a source IP address, a destination IP address, a source port number, a destination port number, and protocol information; (V) information used to provide the RT delay requirement, which may include at least one of: 1. a one-way delay requirement: i.e., the AF provides both uplink and downlink delay requirements, and the RT delay requirement = the uplink delay requirement + the downlink delay requirement; or, the AF provides the one-way delay requirement, and the RT delay requirement is twice the one-way delay requirement; or 2. the RT delay requirement; (VI) information used to assist the PCF in adjusting the uplink PDB and the downlink PDB, which may include at least one of: 1. a period of QoS adjustment: a period of adjusting the PDB of the uplink data flow (also known as UL PDB) and the PDB of the downlink data flow (also known as DL PDB). For example, QoS monitoring is performed on the QoS flow every 20 minutes, and the UL PDB and DL PDB are updated based on a QoS monitoring result; or 2. a threshold of QoS adjustment: when a difference between the QoS monitoring result and the current PDB reaches a set threshold of QoS adjustment, the update of the UL PDB and the DL PDB is triggered; (VII) an alternative parameter, which may include at least one of: 1. an alternative QoS parameter: if the current QoS cannot be met, the access network device may use the alternative QoS parameter and notify the PCF and AF of the alternative QoS parameter, etc.; or 2. an alternative RT delay requirement: if the current RT delay requirement cannot be met, for example, when a round-trip packet delay measured by QoS monitoring is much greater than the current RT delay requirement, the PCF may use the alternative RT delay requirement to re-determine the UL PDB and DL PDB, where the alternative RT requirement may be provided by the AF as a separate parameter in the request message, or may be calculated by the PCF based on the alternative QoS parameter; (VIII) a QoS monitoring requirement, which may include at least one of: 1. a parameter that needs to be measured; 2. a target network element to which a QoS monitoring result is reported; or 3. a condition for reporting the QoS monitoring result, e.g., periodic reporting or reporting when a predetermined threshold is reached; where the parameter that needs to be measured may include at least one of: a packet delay of the uplink data flow, a packet delay of the downlink data flow, or a round-trip packet delay, where the round-trip packet delay includes a round-trip packet delay of the service whose uplink data flow and downlink data flow are carried in different PDU sessions respectively; (IX) information of the tethered device of the UE, which may include at least one of: 1. a device address, e.g., an address of a tethered device of a UE-1 and an address of a tethered device of a UE-2; 2. a device identifier, e.g., an identifier of a tethered device of the UE-1 and an identifier of a tethered device of the UE-2; or 3. a correlation relationship between the tethered device and the UE. where the NEF is responsible for discovering the PCF that serves a PDU session, and the PDU session corresponds to a UE address carried in the request message, and after discovering the PCF serving the PDU session, the NEF forwards the request message to the PCF.

S1002: the PCF requests to acquire the packet delay between the UE and the tethered device of the UE. The implementation methods may be classified into the following two types.

Method I: the PCF acquires the packet delay between the UE and the tethered device during a process of QoS monitoring. In this embodiment, the packet delay between the UE and the tethered device may be referred to as a UE part packet delay, including operations S1002a and S1002b.

S1002a: the PCF initiates QoS monitoring for the UL QoS flow and the DL QoS flow in the PDU sessions corresponding to the UE-1 address and the UE-2 address respectively.

S1002b: the UE and/or the related network device reports the QoS monitoring result to the PCF. In addition to the one-way packet delay of the data flow carried by the PDU session between the UE and the UPF, the QoS monitoring result further includes the packet delay between the UE and the tethered device of the UE. For example, in the example illustrated in FIG. 10, the UE-2 is connected to the tethered device, and the UE-1 is not connected to the tethered device. Therefore, the QoS monitoring result reported by the UE-1 and/or the related network device to the PCF includes the one-way packet delay, and the QoS monitoring result reported by the UE-2 and/or the related network device to the PCF includes the one-way packet delay and the packet delay between the UE and the tethered device.

Method II: the PCF actively requests the UE to report the packet delay between the UE and the tethered device, including operations S1002c and S1002d.

S1002c: the PCF initiates a UE part delay request to UE-1 and UE-2 respectively, where the request message includes at least one of the following parameters: (1) a UE part delay request indication: used to indicate the UE to report the packet delay between the UE and the tethered device of the UE; (2) a device address; for example, when the PCF transmits the request message to the UE-1, an address of a tethered device of the UE-1 is carried; when the PCF transmits the request message to the UE-2, an address of a tethered device of the UE-2 is carried; (3) a device identifier; for example, when the PCF transmits the request message to the UE-1, an identifier of the tethered device of the UE-1 is carried; when the PCF transmits the request message to the UE-2, an identifier of the tethered device of the UE-2 is carried; (4) a UE identifier; (5) a UE address; (6) a DNN (7) S-NSSAI; or (8) flow description information.

S1002d: after receiving the above message, the UE-1 and the UE-2 acquire packet delays between themselves and the tethered device behind them, and report the packet delays to the PCF. If there is no tethered device behind the UE, the returned UE part packet delay is zero, or the acquisition failure is returned. If there are multiple tethered devices behind the UE, the respective packet delay between the UE and each tethered device may be reported, or an average value of the packet delay between the UE and each tethered device, the minimum delay among packet delays between the UE and each tethered device, or the maximum delay among the packet delays between the UE and each tethered device, etc., may be reported; the target tethered device may also be determined based on the device identifier, device address, DNN, S-NSSAI, flow description information, etc., and then the packet delay between the UE and the target tethered device may be reported.

S1003: the PCF determines the UL PDB and the DL PDB based on the RT delay requirement, the packet delay between the UE and the tethered device, and the one-way packet delay measured by QoS monitoring. For example, the PCF or other central node performing uplink and downlink collaboration needs to subtract the packet delay between the UE and the tethered device (e.g., the packet delay between UE-1 and the tethered device and/or the packet delay between UE-2 and the tethered device) from the RT delay requirement provided by the AF, to obtain a new total delay upper limit; then, based on the new total delay upper limit, determines the UL PDB and DL PDB for the uplink and downlink QoS flows, and ensures that a sum of the UL PDB and the DL PDB does not exceed the new total delay upper limit.

S1004: the PCF initiates a PDU session modification process for the UE-1 and the UE-2 respectively. For example, the PCF configures QoS profiles for the UL QoS flow and the DL QoS flow respectively, and the two QoS profiles respectively include the UL PDB and DL PDB determined by the PCF.

S1005: if the request message transmitted by the AF carries the QoS monitoring requirement, the PCF may report the QoS monitoring result to the AF or the target network element designated by the AF. If the parameter the AF requests to measure is the packet delay of the uplink data flow or the packet delay of the downlink data flow, the PCF may directly report the measurement result of the one-way packet delay (that is, the packet delay of the uplink data flow or the packet delay of the downlink data flow) to the AF; if the parameter the AF requests to measure is a round-trip packet delay, the PCF calculates the round-trip packet delay based on the measurement result of the one-way packet delay, and reports the round-trip packet delay to the AF. In addition, as described in an operation S1003, in a case where the RT delay requirement cannot be met by adjusting, by the PCF, the UL PDB and the DL PDB, or the alternative RT delay requirement is enabled, the AF will also be notified.

In this embodiment, taking PCFs serving two PDU sessions of two UEs being the same PCF as an example for description. In other embodiments of the present application, the PCFs serving the two PDU sessions of the two UEs may be different PCFs, and the UE is connected to the tethered device. In this scenario, the NEF transmits the request message to two PCFs respectively. For example, if the PCF-1 serves the PDU session of the UE-1 and the PCF-2 serves the PDU session of the UE-2, the request message transmitted by the NEF to the PCF-1 carries the identifier and/or address of the tethered device of the UE-1, and the request message transmitted by the NEF to the PCF-2 carries the identifier and/or address of the tethered device of the UE-2; the two PCFs may respectively acquire a packet delay between their respective UE and tethered device, and report the acquired packet delay between the UE and the tethered device to the central node for determination of UL/DL PDB; or, the two PCFs may respectively acquire the packet delay between their respective UE and tethered device, and carry the packet delay between the UE and the tethered device in the interaction information when the two PCFs interact, for determination of UL/DL PDB.

In Embodiments I to V, the request message may be carried by a multi-member AF session with required QoS process, and multiple AF sessions with required QoS processes may carry different UE addresses, UE identifiers, flow description information, one-way packet delays, etc., respectively, as well as the same correlation identifier. That is, each Nnef_AFsessionWithQoS_Create request message may include the following information: (1) correlation identifier information; (2) an uplink and downlink collaboration indication: used to indicate the PCF to determine the PDB for the uplink and downlink QoS flows of the target service based on the round-trip delay requirement; (3) an AF identifier; (4) information used to determine the PDU session carrying the service, including: a UE address, e.g., a UE-1 address or a UE-2 address; a UE identifier, e.g., an external identifier GPSI of the UE-1 or an external identifier GPSI of the UE-2; a DNN; S-NSSAI; (4) information used to determine a target QoS flow (or SDF flow), including: uplink flow description information or downlink flow description information: a source/destination IP address, a source/destination port number, and protocol information. (5) information used to provide the round-trip delay requirement, including: a one-way delay requirement: UL PDB or DL PDB; a round-trip delay requirement: i.e., the AF directly provides a total round-trip delay requirement; (6) information used to assist the PCF in adjusting the uplink PDB and the downlink PDB, including: a period of a QoS adjustment: a period of adjusting the period of the UL PDB and the DL PDB, for example, QoS monitoring is performed on the QoS flow every 20 minutes, and the UL PDB and DL PDB are updated based on a QoS monitoring result; a threshold of QoS adjustment: when a difference between the QoS monitoring result and the current PDB reaches a set threshold condition, the update of the UL PDB and the DL PDB is triggered. (7) an alternative parameter, including: alternative QoS: if the current QoS cannot be met, the access network device may use the alternative QoS parameter and notify the PCF and AF of the alternative QoS parameter; an alternative RT requirement; (8) a QoS monitoring requirement, including: a parameter that needs to be measured; a target network element to which a QoS monitoring result is reported; a condition that needs to be met for reporting (periodicity or threshold). (9) information of the tethered device of the UE, which may include at least one of: a device address, a device identifier, or a correlation relationship between the tethered device and the UE.

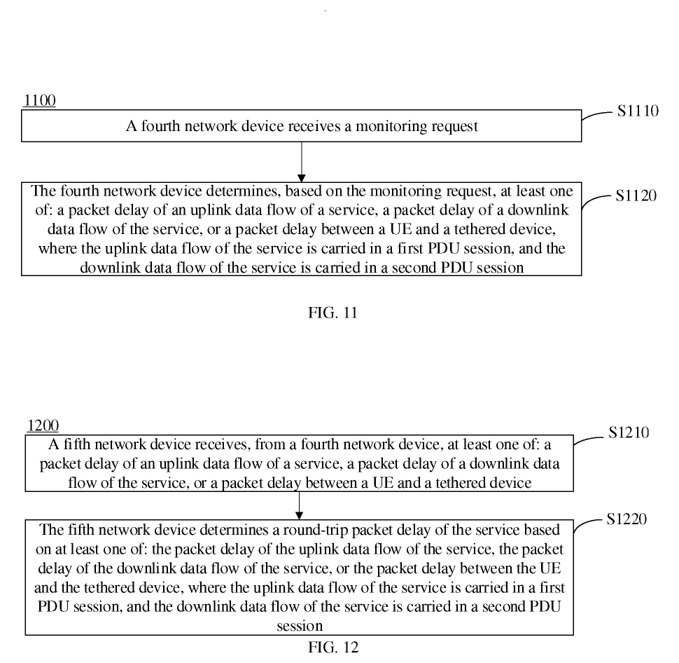

The present application further provides a delay monitoring method that can be applied to scenarios where an uplink data flow and a downlink data flow of the same service are carried in different PDU sessions of different UEs, and a round-trip packet delay of such a service is measured through QoS monitoring. FIG. 11 is a schematic flowchart of a delay monitoring method 1100 according to an embodiment of the present application. This method may optionally be applied to the system illustrated in FIG. 1, FIG. 2A or FIG. 2B, but is not limited thereto. The method includes at least part of the following.

S1110: a fourth network device receives a monitoring request.

S1120: the fourth network device determines, based on the monitoring request, at least one of: a packet delay of an uplink data flow of a service, a packet delay of a downlink data flow of the service, or a packet delay between a UE and a tethered device.

The uplink data flow of the service is carried in a first PDU session, and the downlink data flow of the service is carried in a second PDU session.

A first network device can determine a round-trip packet delay of such a service based on the determined packet delays for the uplink and downlink data flows belonging to the same service and carried in different PDU sessions of different UEs, and the packet delay between the UE and the tethered device.

It should be noted that the "first" and "second" in the above-mentioned first PDU session and second PDU session are only used to distinguish two different PDU sessions, that is, the uplink data flow and the downlink data flow of the same service are carried in two different PDU sessions respectively, and these two different PDU sessions correspond to different UEs. "First" and "second" do not imply order or other meanings such as importance.

The data flow in the embodiments of the present application may also be called a service flow, an SDF, a QoS flow carrying a data flow, or a QoS flow carrying an SDF, etc.

In some implementations, the fourth network device may include a PCF. The PCF may receive, from an AF or NEF, the monitoring request, e.g., a QoS monitoring request.

In some implementations, the first PDU session and the second PDU session may be served by the same PCF. In this case, the fourth network device may be the PCF. The PCF may determine the round-trip packet delay of the service based on the determined packet delay of the uplink data flow, the packet delay of the downlink data flow, and the packet delay between the UE and the tethered device.

In other implementations, the first PDU session and the second PDU session may be served by different PCFs. In this case, the fourth network device may be the PCF serving the first PDU session or the PCF serving the second PDU session. The two PCFs respectively determine the packet delay of the uplink data flow or the packet delay of the downlink data flow, and after determining the packet delay between the UE and the tethered device, the determined packet delay may be reported to a fifth network device, and the fifth network device determines the round-trip packet delay of the service based on the received packet delay. The fifth network device may include a network element, e.g., the NEF.

In some implementations, the monitoring request may carry at least one of: information used to determine a PDU session carrying a service: information used to determine the uplink data flow and/or the downlink data flow; an identifier of the tethered device of the UE; an address of the tethered device of the UE; the QoS monitoring requirement; or a correlation identifier.

The information used to determine the PDU session carrying the service may include at least one of: an address of the UE, an identifier of the UE, a DNN, or S-NSSAI.

The address of the UE may include: an address of a UE corresponding to the first PDU session and/or an address of a UE corresponding to the second PDU session.

The information used to determine the uplink data flow and/or the downlink data flow may include flow description information of the uplink data flow and/or flow description information of the downlink data flow.

Based on the information used to determine the PDU session carrying the service and the information used to determine the uplink data flow and/or the downlink data flow carried in the monitoring request, the fourth network device can determine the uplink data flow and the downlink data flow belonging to the same service. For example, the fourth network device determines that the first PDU session and the second PDU session have the correlation relationship, based on the address of the UE corresponding to the first PDU session and the address of the UE corresponding to the second PDU session; and the fourth network device determines that the uplink data flow and the downlink data flow belong to the same service, based on the correlation relationship between the first PDU session and the second PDU session, the flow description information of the uplink data flow, and the flow description information of the downlink data flow.

In some implementations, the correlation identifier in the monitoring request is used to correlate the uplink data flow and the downlink data flow belonging to the same service. For example, the correlation identifier may be identifier information, e.g., a correlation ID or a group ID. The fourth network device may determine, based on the correlation identifier, that the two data flows with the same correlation identifier are the uplink data flow and the downlink data flow belonging to the same service.

In some implementations, the QoS monitoring requirement indicates at least one of: a parameter that needs to be measured for QoS monitoring; a target network element to which a QoS monitoring result is reported; or a condition for reporting the QoS monitoring result.

The parameter that needs to be measured for QoS monitoring may include at least one of: a packet delay of the uplink data flow, a packet delay of the downlink data flow, or a round-trip packet delay. The round-trip packet delay includes a round-trip packet delay of the service whose uplink data flow and downlink data flow are carried in different PDU sessions respectively.

In some implementations, a manner in which the fourth network device determines, based on the monitoring request, at least one of: the packet delay of the uplink data flow of the service, the packet delay of the downlink data flow of the service, or the packet delay between the UE and the tethered device may include initiating, by the fourth network device, QoS monitoring to obtain at least one of: the packet delay of the uplink data flow, the packet delay of the downlink data flow, or the packet delay between the UE and the tethered device.

Then, the fourth network device may transmit the monitoring result, where the monitoring result includes at least one of: the packet delay of the uplink data flow; the packet delay of the downlink data flow; the packet delay between the UE and the tethered device; or the round-trip packet delay.

The round-trip packet delay may be determined based on the packet delay of the uplink data flow, the packet delay of the downlink data flow, and the packet delay between the UE and the tethered device. For example, the round-trip packet delay is equal to a sum of the packet delay of the uplink data flow, the packet delay of the downlink data flow, and the packet delay between the UE and the tethered device.

If the first PDU session and the second PDU session are served by different PCFs, the two PCFs may respectively report the monitoring result (e.g., the packet delay of the uplink data flow or the packet delay of the downlink data flow, and the packet delay between the UE and the tethered device) to the fifth network device, and the fifth network device calculates the round-trip packet delay based on the received monitoring result. For example, the round-trip packet delay is equal to a sum of the packet delay of the uplink data flow, the packet delay of the downlink data flow, and the packet delay between the UE and the tethered device.

When the PCF reports the monitoring result, the monitoring result may further include the correlation identifier, so that the network element receiving the monitoring result determines to which service the monitoring result corresponds.

The present application further provides a delay monitoring method that can be applied to scenarios where an uplink data flow and a downlink data flow of the same service are carried in different PDU sessions of different UEs, and a round-trip packet delay of such a service is measured through QoS monitoring. FIG. 12 is a schematic flowchart of a delay monitoring method 1200 according to an embodiment of the present application. This method may optionally be applied to the system illustrated in FIG. 1, FIG. 2A or FIG. 2B, but is not limited thereto. The method includes at least part of the following.

S1210: a fifth network device receives from a fourth network device at least one of: a packet delay of an uplink data flow of a service, a packet delay of a downlink data flow of the service, or a packet delay between a UE and a tethered device.

S1220: the fifth network device determines a round-trip packet delay of the service based on at least one of: the packet delay of the uplink data flow of the service, the packet delay of the downlink data flow of the service, or the packet delay between the UE and the tethered device.

The uplink data flow of the service is carried in a first PDU session, and the downlink data flow of the service is carried in a second PDU session.

It should be noted that the "first" and "second" in the above-mentioned first PDU session and second PDU session are only used to distinguish two different PDU sessions, that is, the uplink data flow and downlink data flow of the same service are carried in two different PDU sessions respectively, and these two different PDU sessions correspond to different UEs. "First" and "second" do not imply order or other meanings such as importance.

The data flow in the embodiments of the present application may also be called a service flow, a SDF, a QoS flow carrying a data flow, or a QoS flow carrying an SDF, etc.

In some implementations, the fourth network device may include a PCF. The fifth network device may include a network element, e.g., an NEF.

Further, the fifth network device may receive a correlation identifier from the fourth network device; and determine, based on the correlation identifier, the uplink data flow and the downlink data flow belonging to the same service.

Further, the fifth network device may determine the round-trip packet delay of the service based on at least one of: the packet delay of the uplink data flow, the packet delay of the downlink data flow, or the packet delay between the UE and the tethered device belonging to the same service.

In some implementations, the fifth network device transmits the round-trip packet delay of the service to a target network entity.

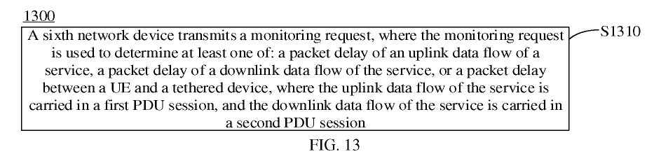

The present application further provides a delay monitoring method that can be applied to scenarios where an uplink data flow and a downlink data flow of the same service are carried in different PDU sessions of different UEs, and a round-trip packet delay of such a service is measured through QoS monitoring. FIG. 13 is a schematic flowchart of a delay monitoring method 1300 according to an embodiment of the present application. This method may optionally be applied to the system illustrated in FIG. 1, FIG. 2A or FIG. 2B, but is not limited thereto. The method includes at least part of the following.

S1310: a sixth network device transmits a monitoring request.

The monitoring request is used to determine at least one of: a packet delay of an uplink data flow of a service, a packet delay of a downlink data flow of the service, or a packet delay between a UE and a tethered device.

The uplink data flow of the service is carried in a first PDU session, and the downlink data flow of the service is carried in a second PDU session.

It should be noted that the "first" and "second" in the above-mentioned first PDU session and second PDU session are only used to distinguish two different PDU sessions, that is, the uplink data flow and the downlink data flow of the same service are carried in two different PDU sessions respectively, and these two different PDU sessions correspond to different UEs. "First" and "second" do not imply order or other meanings such as importance.

The data flow in the embodiments of the present application may also be called a service flow, an SDF, a QoS flow carrying a data flow, or a QoS flow carrying an SDF, etc.

In some implementations, the sixth network device may include an AF, and the AF transmits the monitoring request to a PCF or NEF. In some implementations, the monitoring request carries at least one of: information used to determine a PDU session carrying the service; information used to determine the uplink data flow and/or the downlink data flow; an identifier of a tethered device of the UE; an address of the tethered device of the UE; a QoS monitoring requirement; or a correlation identifier.

The information used to determine the PDU session carrying the service may include at least one of: an address of the UE, an identifier of the UE, a DNN, or S-NSSAI.

The address of the UE may include: an address of a UE corresponding to the first PDU session and/or an address of a UE corresponding to the second PDU session.

The information used to determine the uplink data flow and/or the downlink data flow may include flow description information of the uplink data flow and/or flow description information of the downlink data flow.

In some implementations, the QoS monitoring requirement may indicate at least one of: a parameter that needs to be measured for QoS monitoring; a target network element to which a QoS monitoring result is reported; or a condition for reporting the QoS monitoring result.

The parameter that needs to be measured for QoS monitoring may include at least one of: a packet delay of the uplink data flow; a packet delay of the downlink data flow; or a round-trip packet delay.

The round-trip packet delay may include round-trip packet delays for the uplink data flow and the downlink data flow of the service carried in different PDU sessions respectively.

In some implementations, the correlation identifier is used to correlate the uplink data flow and the downlink data flow belonging to the same service.

With reference to the accompanying drawings and using exemplary embodiments, the monitoring method provided in the present application is described in detail. The monitoring method provided in the present application may realize QoS monitoring in multi-UE scenarios.

### Embodiment VI:

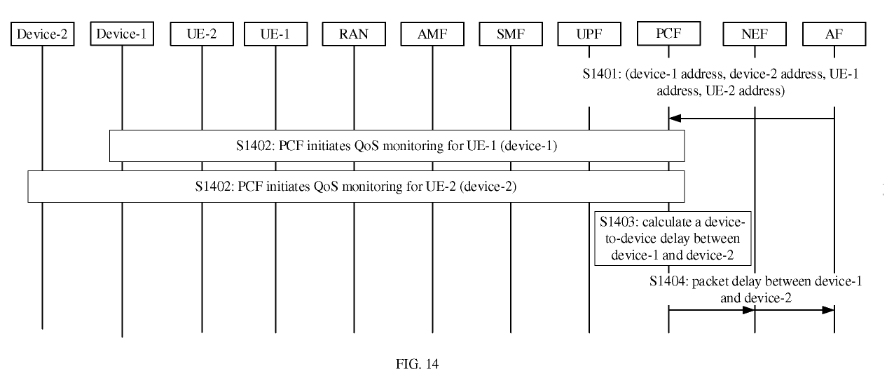

FIG. 14 is a flowchart of Embodiment VI of the present application.

In this embodiment, PCFs serving the two PDU sessions of two UEs are the same PCF. In the application scenario involved in this embodiment, a UE-1 requests to establish a PDU session, a network side selects a UPF-1 as an anchor UPF, and the PDU session carries an uplink data flow (or downlink data flow) of a service; a UE-2 requests to establish a PDU session, a network side selects a UPF-2 as an anchor UPF, and the PDU session carries a downlink data flow (or uplink data flow) of the service. The UPF-1 and the UPF-2 may be the same UPF or different UPFs. The core network element, a UE or AF may request a round-trip delay monitoring for the uplink and downlink data flows of the service carried in different PDU sessions of different UEs. In this embodiment, taking the AF request as an example, the process is as follows.

S1401: the AF initiates a QoS monitoring request, which may be forwarded to the PCF via the NEF or transmitted directly to the PCF. The monitoring request includes at least one of the following information: (1) a group of UE addresses, e.g., a UE-1 address and a UE-2 address; (2) a group of UE identifiers, e.g., an external identifier GPSI of the UE-1 and an external identifier GPSI of the UE-2; or external group identifier information of the UE-1 and the UE 2; (3) one or more device identifiers, including device identifiers of a tethered device of the UE-1 and a tethered device of the UE-2; (4) one or more device addresses, including device addresses of the tethered device of the UE-1 and the tethered device of the UE-2; (5) a DNN; (6) S-NSSAI; (7) a set of flow description information, which may include two flow description information, one for the uplink data flow and the other for the downlink data flow, where the flow description information may include a source IP address, a destination IP address, a source port number, a destination port number, and protocol information; (8) a QoS monitoring requirement, including at least one of: a parameter that needs to be measured; a condition for reporting a measurement result, e.g., reporting triggered by an event and reporting periodically; a threshold of reporting, for example, when a measured parameter reaches the threshold, reporting is triggered; a minimum waiting time between two reports; a period of reporting; a target network element to which the QoS monitoring result is reported, e.g., an NEF, AF, PCF; or a direct reporting instruction, indicating the UPF to report the measurement result directly to the NEF or AF.

The parameter that needs to be measured may include at least one of: a packet delay of an uplink data flow, a packet delay of a downlink data flow or a round-trip packet delay, where the round-trip packet delay includes a round-trip packet delay of the service whose uplink data flow and downlink data flow are carried in different PDU sessions respectively.

S1402: the PCF determines a target QoS flow of a PDU session corresponding to a UE address based on a parameter in the monitoring request, and initiates a process of QoS monitoring respectively to acquire a packet delay between the UE and the UPF.

If the target data flow is further offloaded to a tethered device behind the UE, the packet delay measured by the QoS monitoring further includes the packet delay between the UE and the tethered device of the UE. The tethered device of the UE may be determined by the device identifier and the device address; the UE may also determine to which tethered device the target service flow is offloaded based on the flow description information. In this case, the UE may store a mapping relationship between the data flow and the tethered device of the UE.

If the data flow is forwarded through N6, an N6 delay, i.e., a delay between the UPF and a data network (DN), may also be measured.

S1403: the PCF calculates the round-trip packet delay. Depending on the scenario, the calculation method is as follows.

If the data flow is forwarded through N6, the round-trip packet delay is a sum of the following part packet delays: a packet delay between theUE-1 and the tethered device (if the UE-1 has the tethered device), a packet delay between the UE-2 and the tethered device (if the UE-2 has the tethered device), a packet delay between the UE-1 and the UPF-1, a packet delay between the UE-2 and the UPF-2, a packet delay between the UPF-1 and a data network (DN), and a packet delay between the UPF-2 and a DN, where the UPF-1 and the UPF-2 may be the same UPF or different UPFs.

If the data flow is forwarded by the UPF, the round-trip packet delay is a sum of the following part packet delays: the packet delay between the UE-1 and the tethered device (if the UE-1 has the tethered device), the packet delay between the UE-2 and the tethered device (if the UE-2 has the tethered device), the packet delay between the UE-1 and the UPF-1, the packet delay between the UE-2 and the UPF-2, and a packet delay between the UPF-1 and the UPF-2, where the UPF-1 and the UPF-2 may be the same UPF or different UPFs. In the case that the UPF-1 and the UPF-2 may be the same UPF, the packet delay between the UPF-1 and the UPF-2 is not considered.

S1404: the PCF reports the obtained round-trip delay to the target device.

### Embodiment VII:

FIG. 15 is a flowchart of Embodiment VII of the present application.

In this embodiment, PCFs serving two PDU sessions of two UEs are different PCFs. In the application scenario involved in this embodiment, a UE-1 requests to establish a PDU session, a network side selects a UPF-1 as an anchor UPF, and the PDU session carries an uplink data flow (or downlink data flow) of a service; a UE-2 requests to establish a PDU session, the network side selects a UPF-2 as an anchor UPF, and the PDU session carries a downlink data flow (or uplink data flow) of the service. The UPF-1 and th eUPF-2 may be the same UPF or different UPFs. The core network element, a UE or AF may request round trip delay monitoring for the uplink and downlink data flows of the service carried in different PDU sessions of different UEs. In this embodiment, taking the AF request as an example, the process is as follows.

S1501: the AF initiates a QoS monitoring request, which may be transmitted to an NEF. The information included in the monitoring request is the same as the information included in the monitoring request in Embodiment VI.

S1502: the NEF uses a BSF to discover the PCF-1 and the PCF-2, and transmits the QoS monitoring request to the PCF-1 and the PCF-2 respectively. The QoS monitoring request includes at least one of: (1) a correlation identifier (used to assist the NEF in correlating the uplink and downlink data flows of the same service); (2) a UE address, e.g., a UE-1 address and a UE-2 address; (3) a UE identifier, e.g., an external identifier GPSI of the UE-1 or an external identifier GPSI of the UE-2; (4) one or more device identifiers, e.g., a device identifier of a tethered device of the UE-1 or a device identifier of a tethered device of the UE-2; (5) one or more device addresses, e.g., a device address of the tethered device of the UE-1 or a device address of the tethered device of the UE-2; (6) a DNN; (7) S-NSSAI; (8) a set of flow description information, which may include two flow description information corresponding to the uplink data flow and the downlink data flow respectively, where the flow description information may include a source IP address, a destination IP address, a source port number, a destination port number, and protocol information; (9) a QoS monitoring requirement, including at least one of: a parameter that needs to be measured; a condition for reporting a measurement result, e.g., reporting triggered by an event and reporting periodically; a threshold of reporting, for example, when a measured parameter reaches the threshold, reporting is triggered; a minimum waiting time between two reports; a period of reporting; a target network element to which the QoS monitoring result is reported, e.g., an NEF, AF, PCF; or a direct reporting instruction, indicating the UPF to report the measurement result directly to the NEF or AF.

The parameter that needs to be measured may include a one-way packet delay, e.g., a packet delay between the tethered device of the UE and DN, or a packet delay between the tethered device of the UE and UPF, or a packet delay between the UE and UPF, or a packet delay between the UE and DN, etc.

S1503: the PCF-1 and the PCF-2 respectively initiate a process of QoS monitoring to obtain the one-way packet delay, e.g., a packet delay of an uplink data flow or a packet delay of a downlink data flow.

S1504: the PCF-1 and the PCF-2 may receive the QoS monitoring result transmitted by UPF and report the packet delay of the uplink data flow or the packet delay of the downlink data flow to the NEF; alternatively, the UPF may report the packet delay of the uplink data flow or the packet delay of the downlink data flow obtained by QoS monitoring to the NEF. In addition to the one-way packet delay, the reported information may further include a correlation identifier to assist the NEF in confirming that a pair of uplink and downlink packet delays belong to the same group of services; it may also assist in confirming a pair of uplink and downlink packet delays of the same service by carrying a UE address, a UE identifier, a DNN, S-NSSAI, and flow description information.

S1505: the NEF calculates the round-trip packet delay based on the received one-way packet delay (including the packet delay of the uplink data flow and the packet delay of the downlink data flow). The manner in which the NEF calculates the round-trip packet delay may refer to the manner in which the PCF calculates the round-trip packet delay in Embodiment VI.

S1506: the NEF reports the obtained round-trip packet delay to a target network entity.

From the above, it can be seen that the present application expands the application scenarios of QoS monitoring, so that in scenarios where uplink and downlink SDFs are carried in different PDU sessions of different UEs, the core network element may also measure the round-trip delay of such the service through QoS monitoring.

In addition, the embodiments of the present application extend the uplink and downlink collaboration control mechanism to multi-UE scenarios, and solves the uplink and downlink collaboration problems in scenarios where the uplink and downlink SDFs are carried in different PDU sessions of different UEs under the single PCF service and multi-PCF services, respectively, so that the communication system may adapt to scenarios where multiple users interact through different terminal devices, as well as scenarios where users use the same service through different terminal devices. The system may dynamically adjust the delay budget of QoS flows in different PDU sessions allocated to different terminal devices, realize flexible scheduling of communication resources, thereby improving resource utilization and enhancing user experience without changing the resources occupied by the service.

In addition, when the PCF or central node determines the UL PDB and DL PDB, it also takes into account the possible delay between the terminal device and the tethered device of the terminal device, which improves the accuracy of the PDB configuration and avoids the decline in user experience due to excessive PDB allocation.

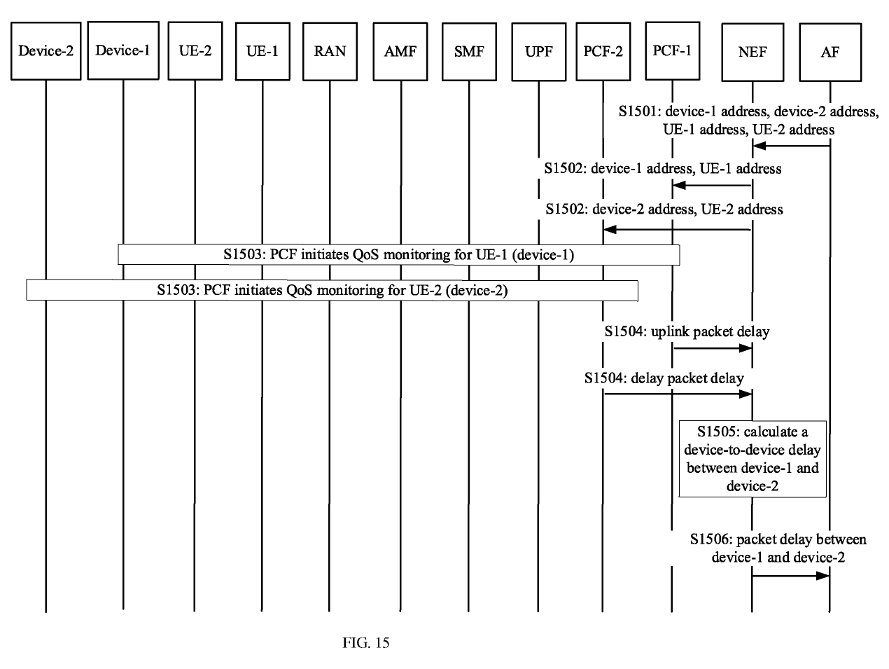

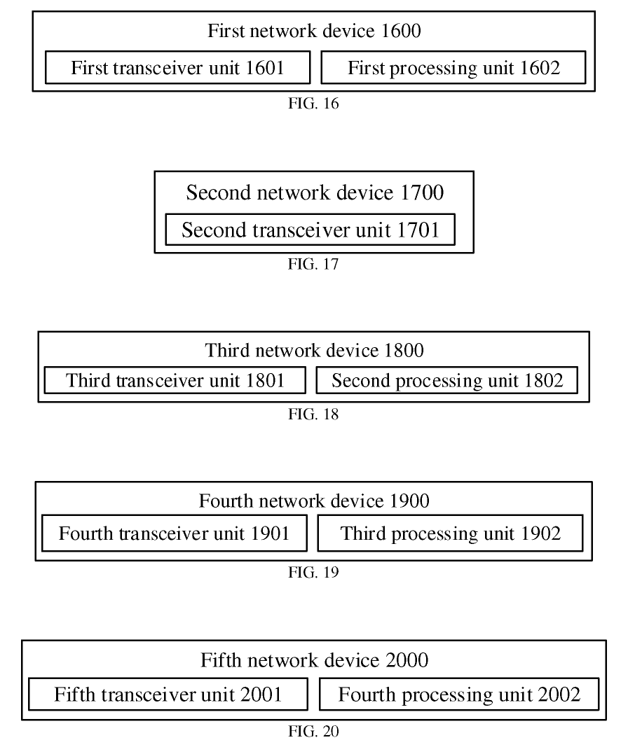

FIG. 16 is a schematic block diagram of a first network device 1600 according to an embodiment of the present application. The first network device 1600 may include: a first transceiver unit 1601, configured to receive a first message, where the first message indicates an RT delay requirement; and a first processing unit 1602, configured to determine, based on the RT delay requirement, at least one of: a PDB of an uplink data flow of a service, or a PDB of a downlink data flow of the service; where the uplink data flow of the service is carried in a first PDU session, and the downlink data flow of the service is carried in a second PDU session. In some implementations, the first message carries at least one of: a one-way delay requirement; an uplink and downlink collaboration indication; an AF identifier; information used to determine a PDU session carrying the service: information used to determine the uplink data flow and/or the downlink data flow; information used to assist the first network device in adjusting an uplink PDB and a downlink PDB; an alternative parameter; a QoS monitoring requirement; a correlation identifier; address(es) and/or identifier(s) of other first network device(s) at a peer side; a one-way packet delay obtained by QoS monitoring; or information of a tethered device of a UE.

In some implementations, function of the uplink and downlink collaboration indication includes at least one of: indicating to determine the RT delay requirement using the one-way delay requirement; indicating to determine, based on the RT delay requirement, the PDB for the uplink data flow of the service and/or the PDB for the downlink data flow of the service; or carrying the RT delay requirement.

In some implementations, the information used to determine the PDU session carrying the service includes at least one of: an address of the UE, an identifier of the UE, a DNN, or S-NSSAI.

In some implementations, the address of the UE includes: an address of a UE corresponding to the first PDU session and/or an address of a UE corresponding to the second PDU session.

In some implementations, the information used to determine the uplink data flow and/or the downlink data flow includes flow description information of the uplink data flow and/or flow description information of the downlink data flow.

In some implementations, the information used to assist the first network device in adjusting the uplink PDB and the downlink PDB includes a period and/or a threshold for adjusting uplink and downlink PDBs.

In some implementations, the correlation identifier is used to indicate that two data flows with a same correlation identifier need to perform uplink and downlink collaboration.

In some implementations, the first processing unit 1602 is further configured to: determine, based on the address of the UE corresponding to the first PDU session and the address of the UE corresponding to the second PDU session, that the first PDU session and the second PDU session have a correlation relationship; and determine, that the uplink data flow and the downlink data flow belong to a same service, based on the correlation relationship between the first PDU session and the second PDU session, the flow description information of the uplink data flow, and the flow description information of the downlink data flow.

In some implementations, the first processing unit 1602 is further configured to: determine, based on the correlation identifier, that the two data flows with a same correlation identifier are an uplink data flow and a downlink data flow belonging to a same service.

In some implementations, the first processing unit 1602 is further configured to: determine the at least one of: the PDB of the uplink data flow of the service or the PDB of the downlink data flow of the service, based on the RT delay requirement, a packet delay of the uplink data flow, or a packet delay of the downlink data flow.

In some implementations, the PDB of the uplink data flow and the PDB of the downlink data flow determined by the first network device meet a following requirement: a sum of the PDB of the uplink data flow and the PDB of the downlink data flow being less than or equal to the RT delay requirement.

In some implementations, determining, by the first network device, the at least one of: the PDB of the uplink data flow of the service, or the PDB of the downlink data flow of the service, based on the RT delay requirement includes: determining, by the first network device, at least one of: the PDB of the uplink data flow of the service, or the PDB of the downlink data flow of the service, based on the RT delay requirement and a packet delay between the UE and the tethered device.

In some implementations, the first processing unit 1602 is further configured to: determine at least one of: the PDB of the uplink data flow of the service, or the PDB of the downlink data flow of the service, based on the RT delay requirement, a packet delay of the uplink data flow, a packet delay of the downlink data flow, and a packet delay between a UE and a tethered device.

In some implementations, the PDB of the uplink data flow and the PDB of the downlink data flow determined by the first network device meet a following requirement: a sum of the PDB of the uplink data flow and the PDB of the downlink data flow being less than or equal to a first delay requirement, and the first delay requirement being equal to the RT delay requirement minus the packet delay between the UE and the tethered device.

In some implementations, the first processing unit 1602 is further configured to: initiate QoS monitoring to obtain at least one of: the packet delay of the uplink data flow, the packet delay of the downlink data flow, or a packet delay between a UE and a tethered device.

In some implementations, the first transceiver unit 1601 is further configured to: transmit a delay request to the UE; and receive from the UE the packet delay between the UE and the tethered device.

In some implementations, the alternative parameter includes: an alternative RT delay requirement, or a parameter used to determine the alternative RT delay requirement.

In some implementations, the first processing unit 1602 is further configured to: in a case where the at least one of: the PDB of the uplink data flow of the service, or the PDB of the downlink data flow of the service cannot be determined based on the RT delay requirement, determine, by the first network device, based on the alternative RT delay requirement, at least one of: the PDB of the uplink data flow of the service, or the PDB of the downlink data flow of the service.

In some implementations, the first processing unit 1602 is further configured to: determine at least one of: the PDB of the uplink data flow, or the PDB of the downlink data flow based on at least one of: the RT delay requirement, a PDB of a one-way data flow determined by other first network device(s), a packet delay between a UE and a tethered device, a packet delay of the uplink data flow, or a packet delay of the downlink data flow, where the PDB of the one-way data flow includes the PDB of the uplink data flow or the PDB of the downlink data flow.

In some implementations, the first network device initiates a session modification process for the first PDU session and/or a session modification process for the second PDU session, to configure a corresponding PDB for the uplink data flow and/or a corresponding PDB for the downlink data flow.

In some implementations, the QoS monitoring requirement indicates at least one of: a parameter that needs to be measured for QoS monitoring; a target network element to which a QoS monitoring result is reported; or a condition for reporting the QoS monitoring result.

In some implementations, the parameter that needs to be measured for QoS monitoring indicated by the QoS monitoring requirement includes at least one of: a packet delay of the uplink data flow; a packet delay of the downlink data flow; or a round-trip packet delay.

In some implementations, the round-trip packet delay includes a round-trip packet delay of the service whose uplink data flow and downlink data flow are carried in different PDU sessions respectively.

In some implementations, the first processing unit 1602 is further configured to report the QoS monitoring result based on the QoS monitoring requirement, where the QoS monitoring result includes at least one of: a packet delay of the uplink data flow, a packet delay of the downlink data flow, or a round-trip packet delay.

In some implementations, the round-trip packet delay reported by the first network device is determined based on at least one of: the packet delay of the uplink data flow, the packet delay of the downlink data flow, or the packet delay between the UE and the tethered device.

In some implementations, the first network device includes a PCF.

In some implementations, the data flow includes a service data flow (SDF), a QoS flow carrying a data flow, or a QoS flow carrying an SDF.

The first network device 1600 in the embodiments of the present application can implement the corresponding functions of the first network device in the aforementioned method embodiments. For the processes, functions, implementation methods and beneficial effects corresponding to various modules (sub-modules, units or components, etc.) in the first network device 1600, please refer to the corresponding description in the above method embodiments, which will not be repeated here. It should be noted that the functions described in relation to the various modules (sub-modules, units or components, etc.) in the first network device 1600 of the embodiments of the present application may be implemented by different modules (sub-modules, units or components, etc.) or by the same module (sub-module, unit or component, etc.).

FIG. 17 is a schematic block diagram of a second network device 1700 according to an embodiment of the present application. The second network device 1700 may include: a second transceiver unit 1701, configured to transmit a first message, where the first message is used to determine an RT delay requirement, and the RT delay requirement is used to determine at least one of: a PDB of an uplink data flow of a service, or a PDB of a downlink data flow of the service; where the uplink data flow of the service is carried in a first PDU session, and the downlink data flow of the service is carried in a second PDU session.

In some implementations, the first message carries at least one of: a one-way delay requirement; an uplink and downlink collaboration indication; an AF identifier; information used to determine a PDU session carrying the service; information used to determine the uplink data flow and/or the downlink data flow; information used to assist a first network device in adjusting an uplink PDB and a downlink PDB; an alternative parameter; a QoS monitoring requirement; a correlation identifier; address(es) and/or identifier(s) of other first network device(s) at a peer side; a one-way packet delay obtained by QoS monitoring; or information of a tethered device of a UE.

In some implementations, the second network device includes an AF.

In some implementations, the first network device includes a PCF.

The second network device 1700 in the embodiments of the present application can implement the corresponding functions of the second network device in the aforementioned method embodiments. For the processes, functions, implementation methods and beneficial effects corresponding to various modules (sub-modules, units or components, etc.) in the second network device 1700, please refer to the corresponding description in the above method embodiments, which will not be repeated here. It should be noted that the functions described in relation to the various modules (sub-modules, units or components, etc.) in the second network device 1700 in the embodiments of the application may be implemented by different modules (sub-modules, units or components, etc.) or by the same module (sub-module, unit or component, etc.).

FIG. 18 is a schematic block diagram of a third network device 1800 according to an embodiment of the present application. The third network device 1800 may include: a third transceiver unit 1801, configured to receive a respective first message from each of two first network devices; and a second processing unit 1802, configured to determine an RT delay requirement based on the first message, and determine, based on the RT delay requirement, at least one of: a PDB of an uplink data flow of a service, or a PDB of a downlink data flow of the service; where the uplink data flow of the service is carried in a first PDU session, and the downlink data flow of the service is carried in a second PDU session.

In some implementations, the first message carries at least one of: a one-way delay requirement; an uplink and downlink collaboration indication; information used to determine a PDU session carrying the service: information used to determine the uplink data flow and/or the downlink data flow; information used to assist the first network device in adjusting an uplink PDB and a downlink PDB; an alternative parameter; a QoS monitoring requirement; a correlation identifier; address(es) and/or identifier(s) of other first network device(s) at a peer side; a one-way packet delay obtained by monitoring; or information of a tethered device of the UE.

In some implementations, the third transceiver unit 1801 is further configured to transmit a respective second message to each of the two first network devices, where the second message carries at least one of: the uplink and downlink collaboration indication; the PDB of the uplink data flow or the PDB of the downlink data flow; a correlation identifier; a DNN; S-NSSAI; or the RT latency requirement.

In some implementations, function of the uplink and downlink collaboration indication includes at least one of: indicating to determine the RT delay requirement using the one-way delay requirement; indicating to determine, based on the RT delay requirement, the PDB for the uplink data flow of the service and/or the PDB for the downlink data flow of the service; or carrying the RT delay requirement.

In some implementations, the third network device includes an NEF or a BSF.

In some implementations, the first network device includes a PCF.

The third network device 1800 in the embodiments of the present application can implement the corresponding functions of the third network device in the aforementioned method embodiments. For the processes, functions, implementation methods and beneficial effects corresponding to various modules (sub-modules, units or components, etc.) in the third network device 1800, please refer to the corresponding description in the above method embodiments, which will not be repeated here. It should be noted that the functions described in relation to the various modules (sub-modules, units or components, etc.) in the third network device 1800 of the embodiments of the application may be implemented by different modules (sub-modules, units or components, etc.) or by the same module (sub-module, unit or component, etc.).

FIG. 19 is a schematic block diagram of a fourth network device 1900 according to an embodiment of the present application. The fourth network device 1900 may include: a fourth transceiver unit 1901, configured to receive a monitoring request; and a third processing unit 1902, configured to determine, based on the monitoring request, at least one of: a packet delay of an uplink data flow of a service, a packet delay of a downlink data flow of the service, or a packet delay between a UE and a tethered device; where the uplink data flow of the service is carried in a first PDU session, and the downlink data flow of the service is carried in a second PDU session.

In some implementations, the monitoring request carries at least one of: information used to determine a PDU session carrying the service: information used to determine the uplink data flow and/or the downlink data flow; an identifier of the tethered of the UE; an address of the tethered of the UE; a QoS monitoring requirement; or a correlation identifier.

In some implementations, the information used to determine the PDU session carrying the service includes at least one of: an address of the UE, an identifier of the UE, a DNN, or S-NSSAI.

In some implementations, the address of the UE includes: an address of a UE corresponding to the first PDU session and/or an address of a UE corresponding to the second PDU session.

In some implementations, the information used to determine the uplink data flow and/or the downlink data flow includes flow description information of the uplink data flow and/or flow description information of the downlink data flow.

In some implementations, the QoS monitoring requirement indicates at least one of: a parameter that needs to be measured for QoS monitoring; a target network element to which a QoS monitoring result is reported; or a condition for reporting the QoS monitoring result.

In some implementations, the parameter that needs to be measured for QoS monitoring indicated by the QoS monitoring requirement includes at least one of: a packet delay of the uplink data flow; a packet delay of the downlink data flow; or a round-trip packet delay.

In some implementations, the round-trip packet delay includes a round-trip packet delay of the service whose uplink data flow and downlink data flow are carried in different PDU sessions respectively.

In some implementations, the correlation identifier is used to correlate an uplink data flow and s downlink data flow belonging to a same service.

In some implementations, the third processing unit 1902 is further configured to: determine, based on the address of the UE corresponding to the first PDU session and the address of the UE corresponding to the second PDU session, that the first PDU session and the second PDU session have a correlation relationship; and determine, based on the correlation relationship between the first PDU session and the second PDU session, flow description information of the uplink data flow, and flow description information of the downlink data flow, that the uplink data flow and the downlink data flow belong to a same service.

In some implementations, the third processing unit 1902 is further configured to: determine, based on the correlation identifier, that the two data flows with the same correlation identifier are the uplink data flow and the downlink data flow belonging to the same service.

In some implementations, the third processing unit 1902 is further configured to: initiate QoS monitoring to obtain at least one of: the packet delay of the uplink data flow, the packet delay of the downlink data flow, or the packet delay between the UE and the tethered device.

In some implementations, the fourth transceiver unit 1901 is further configured to transmit a monitoring result, where the monitoring result includes at least one of: the packet delay of the uplink data flow; the packet delay of the downlink data flow; the packet delay between the UE and the tethered device; or a round-trip packet delay.

In some implementations, the round-trip packet delay is determined based on the packet delay of the uplink data flow, the packet delay of the downlink data flow, and the packet delay between the UE and the tethered device.

In some implementations, the monitoring result further includes the correlation identifier.

In some implementations, the fourth network device includes a PCF.

The fourth network device 1900 in the embodiments of the present application can implement the corresponding functions of the fourth network device in the aforementioned method embodiments. For the processes, functions, implementation methods and beneficial effects corresponding to the various modules (sub-modules, units or components, etc.) in the fourth network device 1900, please refer to the corresponding descriptions in the above method embodiments, which will not be repeated here. It should be noted that the functions described in relation to the various modules (sub-modules, units or components, etc.) in the fourth network device 1900 of the embodiments of the application may be implemented by different modules (sub-modules, units or components, etc.) or by the same module (sub-module, unit or component, etc.).

FIG. 20 is a schematic block diagram of a fifth network device 2000 according to an embodiment of the present application. The fifth network device 2000 may include: a fifth transceiver unit 2001, configured to receive, from a fourth network device, at least one of: a packet delay of an uplink data flow of a service, a packet delay of a downlink data flow of the service, or a packet delay between a UE and a tethered device; and a fourth processing unit 2002, configured to determine a round trip delay of the service based on at least one of: the packet delay of the uplink data flow of the service, the packet delay of the downlink data flow of the service, or the packet delay between the UE and the tethered device; where the uplink data flow of the service is carried in a first PDU session, and the downlink data flow of the service is carried in a second PDU session.

In some implementations, the fifth transceiver unit 2001 is further configured to receive a correlation identifier from the fourth network device; and the fourth processing unit 2002 is further configured to determine, based on the correlation identifier, an uplink data flow and a downlink data flow belonging to a same service.

In some implementations, the fourth processing unit 2002 is further configured to: determine the round trip delay of the service based on at least one of: a packet delay of an uplink data flow, a packet delay of a downlink data flow, or a packet delay between a UE and a tethered device belonging to the same service.

In some implementations, the fifth transceiver unit 2001 is further configured to transmit the round-trip delay of the service to a target network entity.

The fifth network device 2000 in the embodiments of the present application can implement the corresponding functions of the fifth network device in the aforementioned method embodiments. For the processes, functions, implementation methods and beneficial effects corresponding to various modules (sub-modules, units or components, etc.) in the fifth network device 2000, please refer to the corresponding description in the above method embodiments, which will not be repeated here. It should be noted that the functions described in relation to the various modules (sub-modules, units or components, etc.) in the fifth network device 2000 of the embodiments of the application may be implemented by different modules (sub-modules, units or components, etc.) or by the same module (sub-module, unit or component, etc.).

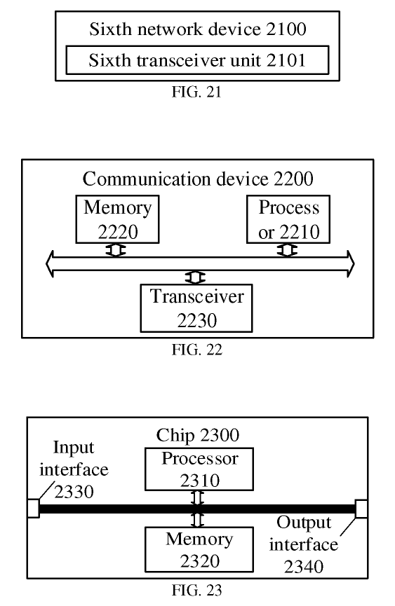

FIG. 21 is a schematic block diagram of a sixth network device 2100 according to an embodiment of the present application. The sixth network device 2100 may include: a sixth transceiver unit 2101, configured to transmit a monitoring request; where the monitoring request is used to determine at least one of: a packet delay of an uplink data flow of a service, a packet delay of a downlink data flow of the service, or a packet delay between a UE and a tethered device; where the uplink data flow of the service is carried in a first PDU session, and the downlink data flow of the service is carried in a second PDU session.

In some implementations, the monitoring request carries at least one of: information used to determine a PDU session carrying the service: information used to determine the uplink data flow and/or the downlink data flow; an identifier of the tethered device of the UE; an address of the tethered device of the UE; a QoS monitoring requirement; or a correlation identifier.

In some implementations, the information used to determine the PDU session carrying the service includes at least one of: an address of the UE, an identifier of the UE, a DNN, or S-NSSAI.

In some implementations, the address of the UE includes: an address of a UE corresponding to the first PDU session and/or an address of a UE corresponding to the second PDU session.

In some implementations, the information used to determine the uplink data flow and/or the downlink data flow includes flow description information of the uplink data flow and/or flow description information of the downlink data flow.

In some implementations, the QoS monitoring requirement indicates at least one of: a parameter that needs to be measured for QoS monitoring; a target network element to which a QoS monitoring result is reported; or a condition for reporting the QoS monitoring result.

In some implementations, the parameter that needs to be measured for QoS monitoring indicated by the QoS monitoring requirement includes at least one of: the packet delay of the uplink data flow; the packet delay of the downlink data flow; or a round-trip packet delay.

In some implementations, the round-trip packet delay includes a round-trip packet delay of the service whose uplink data flow and downlink data flow are carried in different PDU sessions respectively.

In some implementations, the correlation identifier is used to correlate an uplink data flow and a downlink data flow belonging to the same service.

In some implementations, the sixth network device includes an AF.

The sixth network device 2100 in the embodiments of the present application can implement the corresponding functions of the sixth network device in the aforementioned method embodiments. For the processes, functions, implementation methods and beneficial effects corresponding to various modules (sub-modules, units or components, etc.) in the sixth network device 2100, please refer to the corresponding description in the above method embodiments, which will not be repeated here. It should be noted that the functions described in relation to the various modules (sub-modules, units or components, etc.) in the sixth network device 2100 in the embodiments of the application may be implemented by different modules (sub-modules, units or components, etc.) or by the same module (sub-module, unit or component, etc.).

FIG. 22 is a schematic structural diagram of a communication device 2200 according to the embodiments of the present application. The communication device 2200 includes a processor 2210, which may call and run a computer program from a memory to enable the communication device 2200 to implement the method in the embodiments of the present application.

In an implementation, the communication device 2200 may further include a memory 2220. The processor 2210 may call and run a computer program from the memory 2220 to enable the communication device 2200 to implement the method in the embodiments of the present application.

The memory 2220 may be a separate device independent of the processor 2210, or may be integrated into the processor 2210.

In an implementation, the communication device 2200 may further include a transceiver 2230, and the processor 2210 may control the transceiver 2230 to communicate with other devices. For example, the transceiver 2230 may transmit information or data to other devices, or receive information or data transmitted by other devices.

The transceiver 2230 may include a transmitter and a receiver. The transceiver 2230 may further include an antenna, and the number of antennas may be one or more.

In an implementation, the communication device 2200 may be a network device in the embodiments of the present application, and the communication device 2200 may implement the corresponding processes implemented by the network device in various methods in the embodiments of the present application. For the sake of brevity, they will not be repeated here.

FIG. 23 is a schematic structural diagram of a chip 2300 according to the embodiments of the present application. The chip 2300 includes a processor 2310, which may call and run a computer program from a memory to implement the method in the embodiments of the present application.

In an implementation, the chip 2300 may further include a memory 2320. The processor 2310 may call and run a computer program from the memory 2320 to implement the method performed by the terminal device or network device in the embodiments of the present application.

The memory 2320 may be a separate device independent of the processor 2310 or may be integrated into the processor 2310.

In an implementation, the chip 2300 may further include an input interface 2330. The processor 2310 may control the input interface 2330 to communicate with other devices or chips, and for example, may obtain information or data transmitted by other devices or chips.

In an implementation, the chip 2300 may further include an output interface 2340. The processor 2310 may control the output interface 2340 to communicate with other devices or chips, and for example, may output information or data to other devices or chips.

In an implementation, the chip may be applied to the network device in the embodiments of the present application, and the chip may implement the corresponding processes implemented by the network device in various methods in the embodiments of the present application. For the sake of brevity, they will not be repeated here.

The chips used in the network devices may be the same chip or different chips.

It should be understood that the chip mentioned in the embodiments of the present application may also be called a system-level chip, a system chip, a chip system or a system-on-chip chip, etc.

The processor mentioned above may be a general-purpose processor, a digital signal processor (DSP), a field programmable gate array (FPGA), an application specific integrated circuit (ASIC), or other programmable logic devices, transistor logic devices, discrete hardware components, etc. The general-purpose processor mentioned above may be a microprocessor or any conventional processor.

The above-mentioned memory may be a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that the above memory is exemplary but not limiting illustration, e.g., the memory in the embodiments of the present application may also be a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a direct rambus RAM (DR RAM), etc. That is, the memory in the embodiments of the present application is intended to include, but is not limited to, these and any other suitable types of memories.

The above embodiments may be implemented in whole or in part through software, hardware, firmware, or any combination thereof. When the embodiments are implemented by using a software program, the software program may be implemented in a form of a computer program product in whole or in part. The computer program product includes one or more computer instructions. When computer program instructions are loaded on and executed by a computer, processes or functions according to the embodiments of the present application are generated in whole or in part. The computer may be a general-purpose computer, a dedicated computer, a computer network, or any other programmable device. The computer instructions may be stored in a computer-readable storage medium or transmitted from a computer-readable storage medium to another computer-readable storage medium. For example, the computer instructions may be transmitted from a website, computer, server or data center to another website, computer, server or data center via a wired manner (such as coaxial cable, optical fiber, or digital subscriber line (DSL)) or a wireless manner (such as infrared, wireless or microwave). The computer-readable storage medium may be any available medium able to be accessed by the computer, or may be a data storage device, such as a server or a data center, integrated by one or more available media. The available medium may be a magnetic medium (e.g., a floppy disk, a hard disk or a magnetic tape), an optical medium (e.g., a DVD), a semiconductor medium (e.g., a solid state drive (SSD)), or the like.

It should be understood that in the various embodiments of the present application, the magnitude of the serial number of each of the above-mentioned processes does not mean the order of execution. The order of execution of each process shall be determined by its function and internal logic, and shall not constitute any limitation on the implementation process of the embodiments of the present application.

It may be clearly understood by those skilled in the art that, for convenience and brevity of the description, the working procedures of the system, the apparatus and the unit described above may refer to the corresponding procedures in the above method embodiments, which will not be repeated here.

The above content is only exemplary implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A first network device, comprising: a transceiver, a processor and a memory, wherein the memory is configured to store a computer program, the transceiver is configured to communicate with other devices, and the processor is configured to call and run the computer program stored in the memory to enable the first network device to perform:
receiving a first message, wherein the first message indicates a round-trip (RT) delay requirement; and
determining, based on the RT delay requirement, at least one of: a packet delay budget (PDB) of an uplink data flow of a service, or a PDB of a downlink data flow of the service;
wherein the uplink data flow of the service is carried in a first protocol data unit (PDU) session, and the downlink data flow of the service is carried in a second PDU session.

2. The first network device according to claim 1, wherein the first message carries at least one of:
a one-way delay requirement;
an uplink and downlink collaboration indication;
an application function (AF) identifier;
information used to determine a PDU session carrying the service;
information used to determine the uplink data flow and/or the downlink data flow;
information used to assist the first network device in adjusting an uplink PDB and a downlink PDB;
an alternative parameter;
a quality of service (QoS) monitoring requirement;
a correlation identifier;
address(es) and/or identifier(s) of other first network device(s) at a peer side;
a one-way packet delay obtained by QoS monitoring; or
information of a tethered device of user equipment (UE).

3. The first network device according to claim 2, wherein function of the uplink and downlink collaboration indication comprises at least one of:
indicating to determine the RT delay requirement using the one-way delay requirement;
indicating to determine, based on the RT delay requirement, the PDB for the uplink data flow of the service and/or the PDB for the downlink data flow of the service; or
carrying the RT delay requirement;
or
the information used to determine the PDU session carrying the service comprises at least one of: an address of the UE, an identifier of the UE, a data network name (DNN), or single network slice selection assistance information (S-NSSAI); wherein
the address of the UE comprises:
an address of a UE corresponding to the first PDU session and/or an address of a UE corresponding to the second PDU session;
or
the information used to determine the uplink data flow and/or the downlink data flow comprises flow description information of the uplink data flow and/or flow description information of the downlink data flow;
or
the information used to assist the first network device in adjusting the uplink PDB and the downlink PDB comprises a period and/or a threshold for adjusting the uplink PDB and the downlink PDB;
or
the correlation identifier is used to indicate that two data flows with a same correlation identifier need to perform uplink and downlink collaboration.

4. The first network device according to claim 3, wherein the first network device is further configured to perform:
determining, based on the address of the UE corresponding to the first PDU session and the address of the UE corresponding to the second PDU session, that the first PDU session and the second PDU session have a correlation relationship; and
determining that the uplink data flow and the downlink data flow belong to a same service, based on the correlation relationship between the first PDU session and the second PDU session, the flow description information of the uplink data flow, and the flow description information of the downlink data flow.

5. The first network device according to claim 2, wherein the first network device is further configured to perform:
determining, based on the correlation identifier, that two data flows with a same correlation identifier are an uplink data flow and a downlink data flow belonging to a same service.

6. The first network device according to claim 1, wherein the first network device is configured to perform:
determining the at least one of: the PDB of the uplink data flow of the service, or the PDB of the downlink data flow of the service, based on the RT delay requirement, a packet delay of the uplink data flow, and a packet delay of the downlink data flow;
or
determining the at least one of: the PDB of the uplink data flow of the service, or the PDB of the downlink data flow of the service, based on the RT delay requirement and a packet delay between a UE and a tethered device;
or
determining the at least one of: the PDB of the uplink data flow of the service, or the PDB of the downlink data flow of the service, based on the RT delay requirement, a packet delay of the uplink data flow, a packet delay of the downlink data flow, and a packet delay between a UE and a tethered device.

7. The first network device according to claim 1, wherein
the PDB of the uplink data flow and the PDB of the downlink data flow determined by the first network device meet a following requirement:
a sum of the PDB of the uplink data flow and the PDB of the downlink data flow being less than or equal to the RT delay requirement;
or
the PDB of the uplink data flow and the PDB of the downlink data flow determined by the first network device meet a following requirement:
a sum of the PDB of the uplink data flow and the PDB of the downlink data flow being less than or equal to a first delay requirement, and the first delay requirement being equal to the RT delay requirement minus a packet delay between a UE and a tethered device.

8. The first network device according to claim 6, wherein the first network device is further configured to perform:
initiating quality of service (QoS) monitoring, to obtain at least one of: the packet delay of the uplink data flow, the packet delay of the downlink data flow, or a packet delay between a UE and a tethered device.

9. The first network device according to claim 6, wherein the first network device is further configured to perform:
transmitting a delay request to the UE; and
receiving from the UE the packet delay between the UE and the tethered device.

10. The first network device according to claim 1, wherein the first network device is further configured to perform:
in a case where the at least one of: the PDB of the uplink data flow of the service, or the PDB of the downlink data flow of the service cannot be determined based on the RT delay requirement, determining, based on an alternative RT delay requirement, the at least one of: the PDB of the uplink data flow of the service, or the PDB of the downlink data flow of the service.

11. The first network device according to claim 1, wherein wherein the first network device is configured to perform:
determining at least one of: the PDB of the uplink data flow, or the PDB of the downlink data flow, based on at least one of: the RT delay requirement, a PDB of a one-way data flow determined by other first network device(s), a packet delay between a UE and a tethered device, a packet delay of the uplink data flow, or a packet delay of the downlink data flow, wherein the PDB of the one-way data flow comprises the PDB of the uplink data flow or the PDB of the downlink data flow.

12. The first network device according to claim 1, wherein the first network device is further configured to perform:
initiating a session modification process for the first PDU session and/or a session modification process for the second PDU session, to configure a corresponding PDB for the uplink data flow and/or a corresponding PDB for the downlink data flow.

13. The first network device according to claim 2, wherein the QoS monitoring requirement indicates at least one of:
a parameter that needs to be measured for QoS monitoring;
a target network element to which a QoS monitoring result is reported; or
a condition for reporting the QoS monitoring result.

14. The first network device according to claim 13, wherein the parameter that needs to be measured for QoS monitoring indicated by the QoS monitoring requirement comprises at least one of:
a packet delay of the uplink data flow;
a packet delay of the downlink data flow; or
a round-trip packet delay;
wherein the round-trip packet delay comprises a round-trip packet delay of the service whose uplink data flow and downlink data flow are carried in different PDU sessions respectively.

15. The first network device according to claim 13, wherein the first network device is further configured to perform:
reporting the QoS monitoring result based on the QoS monitoring requirement, wherein the QoS monitoring result comprises at least one of: a packet delay of the uplink data flow, a packet delay of the downlink data flow, or a round-trip packet delay.

16. The first network device according to claim 15, wherein the round-trip packet delay reported by the first network device is determined based on at least one of: the packet delay of the uplink data flow, the packet delay of the downlink data flow, or a packet delay between the UE and the tethered device.

17. The first network device according to claim 1, wherein a data flow comprises a service data flow (SDF), a quality of service (QoS) flow carrying a data flow, or a QoS flow carrying an SDF.

18. A second network device, comprising: a transceiver, a processor and a memory, wherein the memory is configured to store a computer program, the transceiver is configured to communicate with other devices, and the processor is configured to call and run the computer program stored in the memory to enable the second network device to perform:
transmitting a first message, wherein the first message is used to determine a round-trip (RT) delay requirement, and the RT delay requirement is used to determine at least one of: a packet delay budget (PDB) of an uplink data flow of a service, or a PDB of a downlink data flow of the service;
wherein the uplink data flow of the service is carried in a first protocol data unit (PDU) session, and the downlink data flow of the service is carried in a second PDU session.

19. The second network device according to claim 18, wherein the first message carries at least one of:
a one-way delay requirement;
an uplink and downlink collaboration indication;
an application function (AF) identifier;
information used to determine a PDU session carrying the service;
information used to determine the uplink data flow and/or the downlink data flow;
information used to assist a first network device in adjusting an uplink PDB and a downlink PDB;
an alternative parameter;
a quality of service (QoS) monitoring requirement;
a correlation identifier;
address(es) and/or identifier(s) of other first network device(s) at a peer side;
a one-way packet delay obtained by QoS monitoring; or
information of a tethered device of user equipment (UE).

20. The second network device according to claim 18, wherein the second network device comprises an application function (AF); or
a first network device comprises a policy control function (PCF).
